(19) United States
(12) Patent Application Publication
(10) Pub. No.: US 2011/0197970 A1
(43) Pub. Date: Aug. 18, 2011

(54) FLUID PROCESSING UNIT COMPRISING ONE OR MORE CASSETTES

(75) Inventors: Finn Beldring, Virum (DK); Christian Rasmussen, Tjele (DK)

(73) Assignee: Grundfos Management A/S, Bjerringbro (DK)

(21) Appl. No.: 12/672,979

(22) PCT Filed: Aug. 15, 2008
(86) PCT No.: PCT/DK2008/050203

§ 371 Date: Apr. 21, 2011

(30) Foreign Application Priority Data
Aug. 17, 2007 (DK) PA 2007 01182

(51) Int. Cl. F15D 1/00; B01J 8/00; F04D 13/16

(52) U.S. Cl. 137/1; 422/187; 137/343; 137/803; 137/560

(57) ABSTRACT

The present invention relates to a fluid processing unit through which fluid may flow while being processed. The fluid processing unit comprises a casing and one or more cassettes each comprising an outer housing being arranged so that the outer housing forms at least a part of the casing and each comprising a flow passage through the cassette. At least one of the cassettes comprises at least one fluid interaction component or is adapted to receive at least one fluid interaction component. The fluid processing unit comprises total pressure increasing means for at least partially overcoming the pressure loss due to the fluid flowing through the unit, the total pressure increasing means and one, more or all of the one or more fluid interaction components being encapsulated by the casing. The invention further relates to a cassette comprising an outer housing being arranged so that the outer housing forms at least a part of a casing of a fluid processing unit when at least two cassettes are combined to form at least a part of the fluid processing unit, the cassette further comprising a flow passage through the cassette and the cassette further comprises or is adapted to receive at least one fluid interaction component. The invention further relates to a method for providing an interaction between a fluid and an interaction component, the method comprising feeding fluid to a fluid processing unit as described above.

The present invention relates a to fluid processing unit comprising one or more cassettes of which at least one comprises at least one fluid interaction component, and in particular to a fluid processing unit comprising total pressure increasing means for at least partially overcoming the pressure loss due to the fluid flowing through the unit. The present invention further relates to a method of providing an interaction between a fluid and a fluid interaction component.

### BACKGROUND OF THE INVENTION

Fluid is processed in a number of ways. For instance, fluid is exposed to electromagnetic radiation in the form of UV light, and/or one or more additives are added to the fluid. Systems for performing such processing are today build from a number of stand alone units, such as pumps, mixing units etc., and these stand alone units are connected to each other by pipes, flanges or the like.

Each such connection typically represents a loss in pressure, e.g. due to change in flow cross section. A connection may furthermore be subjected to sealing problems e.g. where the piping and a stand alone unit are connected to each other.

Furthermore, fluid processing units built from a number of stand-alone units often suffer from the drawback that a single stand-alone unit does not meet a given demand—either the capacity of each unit is too small so that two or more units may be used, or the capacity is too high. In both cases the result is often that the capacity of the unit will overshoot the demand which results in a poor energy efficiency.

Patent Application WO 2007/05013 discloses a system for mixing a first fluid with substances while the fluid exchanges heat with a second fluid. The invention disclosed therein is characterised in that the first fluid flows through a channel provided in a plate, and the addition of substances is provided where the channel has bends or is curved. The channel is connected to an inlet and an outlet positioned in the same geometrical plane as the plate. However, the flow throughout the devices according to WO 2007/05013 is provided by pressure means situated outside the system whereby piping and flanges are needed in order to connect the system with a pump.

While some attempts have been made to provide some modularity as disclosed e.g. in U.S. Pat. No. 4,025,225 and EP 1 231 384, these attempts are limited to modules having either a pressurization function or a fluid interaction function being different from pressurization, e.g. filtration or UV radiation.

Thus, an object of the present invention may preferably be to provide a fluid processing unit seeking to at least mitigating some or all of the above mentioned problems.

### DISCLOSURE OF THE INVENTION

The present invention relates in a first aspect to a fluid processing unit through which fluid may flow while being processed, the fluid processing unit comprising preferably
a casing,
one or more cassettes each comprising an outer housing being arranged so that the outer housing forms at least a part of the casing and each comprising a flow passage through the cassette,
   wherein
at least one of the cassettes comprises at least one fluid interaction component or is adapted to receive at least one fluid interaction component, and
the fluid processing unit comprises total pressure increasing means for at least partially overcoming the pressure loss due to the fluid flowing through the unit, the total pressure increasing means and one, more or all of one or more fluid interaction components being encapsulated by the casing.

Cassettes according to the present invention preferably comprise total pressure increasing means and at least one fluid interaction components. Thereby, a cassette can in many cases be considered as a fluid processing unit for which, if the total pressure increasing means is selected appropriately, no further means is/are needed to pump the fluid through the cassette. This makes the design of a given fluid processing unit very easy.

Thus, the present invention comprises a casing encapsulating the total pressure increasing means and the fluid interaction components. It should be mentioned that the fluid interaction component may comprise a section extending outside the casing. However such a part is typically considered as a handle, a carrier, connection or similar for the part of the fluid interaction component that actually interacts with the fluid. As examples, a sensor may be arranged on a handle where the handle extends outside the casing and the sensor is arranged inside the casing, a nozzle where one or more outlets are arranged inside the casing and e.g. a handle is extending outside the casing. Although the present description focus on processing one fluid the invention is well suited for processing more than one fluid.

By utilizing processing units according to present invention, the state of the fluid flowing through such a unit is changed from a first state being referred to as the inflow state, to a second state, being referred to as the outlet state. The change in state is the result of processing the fluid which processing is provided by the fluid interacting with the one or more fluid interaction components. In some preferred embodiments, the only processing of the fluid is one or more measurement carried out on the fluid and in such cases the change in stage may be so small that it can not be detected.

In accordance with the present invention, a fluid processing unit has a casing which preferably may be considered as a container like structure inside which the one or more fluid interaction components and the total pressure increasing means are arranged. Thereby the need for connecting stand-alone units by pipes to provide a processing unit is avoided and a compact unit providing a good possibility to meet a given processing demand may be provided.

The change in state of the fluid and the flow through the unit will typically result in a pressure loss e.g. due to a flow path designed specifically to guide the fluid to flow in close vicinity of the fluid interaction component and/or to provide a mixing of the fluid with a substance. Typically and preferably, the change in state of the fluid should be broadly interpreted e.g. to include a change of the composition of the fluid and/or a change in the thermo dynamical state of the fluid although a pressurization is preferably provided by total pressure increasing means, typically comprising one or more impellers, and the fluid interaction components preferably provide changes in states being different from a pressure change. The total pressure increasing means is/are typically used to overcome at least the pressure loss resulting from the fluid interacting with or being led to interact with the fluid interaction component, and/or pressure loss resulting from the interaction, e.g. mixing.

Thus, while many of the known fluid processing units are assembled by connecting a number of stand-alone units via pipes, the present invention is designed so that it preferably comprises a pressure carrying casing with a number of cassettes, whereby the unit may be made more compact and efficient. The efficiency of the unit may furthermore be increased as the number of cassettes may be chosen so that a given demand may be matched more accurately than by building a fluid processing unit from a number of stand-alone units.

In the present context a number of terms are used. Although these terms are used in a manner ordinary to a person skilled in the art, a brief explanation will be presented below on some of these terms.

Cassette is preferably used to designate an element which either contains a fluid interaction component, is adapted to receive a fluid interaction component or both. A cassette typically comprises an outer housing arranged so as to form at least part of the casing, one or more inlet(s) and one or more outlet(s). The outer housing may preferably be pressure carrying in the sense that no further casing is needed to withstand the pressure difference between the interior and exterior of the cassette. Furthermore, the outer housing typically and preferably contributes to defining the flow passage through cassette. A cassette is shaped so that it comprises a flow passage through the cassette from its inlet(s) to its outlet(s). The inlet(s) and outlet(s) of cassettes are openings in the cassettes in which fluid may flow into and out of the cassettes and are preferable provided so that when two cassettes are combined, the outlet(s) of one cassette is (are) directly connected to the inlet(s) of the other cassette and vice versa. “Directly connected” is preferably used to designate a situation where the velocity and pressure of the fluid flowing out of an outlet is the same as the velocity and pressure of the fluid flowing into an inlet, which e.g. may be provided by connecting the outlet and inlet with each other with no intermediate piping in between. Furthermore, when two or more cassettes are combined, the outer housings of the cassettes are preferably combined to form at least part of the pressuring carrying casing of the processing unit. Furthermore, as a cassette often comprises total pressure increasing means overcoming the pressure loss due to fluid flowing though the cassette, the assembled unit may often be pressure neutral to the process in which it is to operate. Additionally, when total pressure increasing means is present in the cassette, a cassette is preferably designed so that flow of at least one fluid through the cassette is pressure neutral or the pressure of the fluid in question flowing through the cassette is even increased.

Combine is preferably used to designate a configuration where cassettes are in fluid communication with each other. Typically and preferably the cassettes are combined in a stack of consecutive cassettes in stream wise direction.

Flow passage is preferably used to designate a space, such as one or more channels through which a fluid flows within the cassette. The fluid enters the cassette via an inlet and leaves the cassette via an outlet.

Fluid interaction component is preferably used to designate a member which is adapted to interact with the fluid flowing through the cassette to provide a processing of the fluid. In some embodiments, the interaction results in a change mainly of the fluid, whereas in other embodiments the interaction results in a change mainly of the fluid interaction component. An example of the first type of interaction is UV-processing of water; i.e. that the fluid interaction component is e.g. an UV-lamp. A further example of the first type is addition of one or more substances to a fluid; i.e. the fluid interaction component is a dosing device, e.g. a nozzle. An example of the second type of interaction is measuring of the pH-value of the fluid; i.e. that the fluid interaction component is a pH-meter. In still other applications changes in both the fluid and the fluid interaction component may take place as a result of the interaction. An example could be heat exchange between the fluid and a heat exchanger comprising a second fluid—in this example, the heat exchanger is considered to be the fluid interaction component. These types of interaction may be combined into a single unit. A further example of a fluid interaction component is a mixing chamber in which mixing between a fluid and e.g. a chemical substance or one between two or more fluids takes place.

Interaction introducing zone is preferably used to designate the part of the flow passage where the interaction between the fluid interaction component and the fluid is initiated. The processing may continue both up and downstream of the zone where the interaction is initiated. For instance, if the interaction is addition of one or more substances to the fluid via a nozzle, the outlet of the nozzle is typically referred to as the interaction introducing zone, and the continued interaction in the form of mixing, chemical reaction or the like, will typically continue downstream of the nozzle outlet. In another example, the interaction is exposing the fluid to electromagnetic radiation, and in this case the interaction introducing zone is typically the interface between the electromagnetic radiation source and the fluid; the interaction may typically extend both upstream and downstream of this interface. Furthermore, the interaction may be the result of e.g. interference within the fluid between two or more sources of e.g. electromagnetic radiation. In such cases the interaction introducing zone is also considered to be the interfaces between the sources and the fluid although the sources may be pointed both upstream and downstream.

Interaction introducing passage is preferably used to designate a part of the flow passage where the fluid interaction component is placed and/or a passage designed to guide the fluid towards the fluid interaction component. In some preferred embodiment, the interaction introducing passage comprises the interaction introducing zone. The dimensions and shape of the passage should preferably be so that it is ensured that the interaction between the fluid interaction component and the fluid is sufficient for the actual application.

Fluid is used to designate at least liquid, gas, a fluidized medium or combinations thereof.

Casing is preferably used to designate the wall of the fluid processing unit which wall confines fluid in the processing unit so that fluid may flow out of/into the processing unit through one or more inlets and outlets provided in the casing. Thus, the casing thereby forms a sealed encapsulation of the unit. The casing comprises preferably a number of wall elements. At least a part of the casing may preferably constitute a part of the flow passage of the unit.

Total pressure increasing means is preferably used to designate an element increasing the total pressure (stagnation pressure) of a fluid. A total pressure increasing means preferably is or comprises a velocity inducer, such as an impeller.

Velocity inducer is preferably used to designate an element inducing velocity to the fluid so that its direction and/or total pressure is changed. A fluid velocity inducer is preferably an impeller.

Inlet/outlet is preferably used to designate a cross section or a region where fluid flows into or out of an element such as a cassette or unit. The inlet/out may preferably be an end cross section or a region of a pipe, channel or the like. Inlet and outlet may preferably also be considered as the sections of a control volume through which fluid flow into the element/out of the element which control volume encircles the element in question.

In accordance with a preferred aspect of the invention, the cassette may be configurable in the sense that it can be configured and/or reconfigured to perform one or more processes, such as addition of one or more substances to the fluid, exposing the fluid to electromagnetic radiation, exchanging heat with the fluid, and/or measuring one or more properties of the fluid.

In many preferred embodiments, a fluid processing unit may preferably comprise more than one cassette. Preferably, the cassettes may be combinable, such as stackable, to form the fluid processing unit or at least a part thereof.

Preferably, at least one of the cassette comprises at least one fluid interaction component and a total pressure increasing means. Such cassette has inter alia the advantage that it comprises total pressure increasing means for pumping the fluid through the cassette and the fluid interaction component(s) selected to provide a given treatment. Hereby the cassette may be considered as being configured—for instance as a “plug and play” cassette.

In preferred embodiments, wherein the unit comprises more than one cassette, the cassettes may preferably be combinable whereby the fluid processing unit comprises a number of combined cassettes. Furthermore, more than one of the cassettes may preferably each comprise at least one fluid interaction component and a total pressure increasing means.

Preferably one or more of the cassettes may comprise an interaction introducing passage in the flow passage.

Preferably the casing may be pressure carrying.

Preferred embodiments of units according to the present invention may further comprise an outlet element arranged downstream of the one or more cassettes and/or an inlet element being arranged upstream of the one or more cassettes, the outer surface of the outlet element and/or inlet element may preferably comprise an outer housing being arranged so that the outer housing(s) may form at least part of the casing of the processing unit. The total pressure increasing means, or at least some of them, may preferably be arranged in the inlet and/or outlet element.

In preferred embodiments of a fluid processing unit, the one or more cassettes may preferably be arranged along a common axis.

In preferred embodiments of a fluid processing unit according to the present invention, the fluid processing unit may preferably comprise a number of total pressure increasing means in the form of impellers, and some or all of the impellers may be rotated by a common shaft. Preferably, some or all of the impellers may be arranged in cassettes.

The outer geometry of all cassettes in preferred embodiments of fluid processing units may preferably be equal. Alternatively or in combination therewith, the cross section of the outer housing of the one or more cassettes may be constant along one direction.

Preferably, the outer housing of one or more of the cassettes may preferably form at least a part of an outer surface of the casing. Alternatively or in combination therewith the outer housing may preferably abut an interior surface of the casing.

Preferably, one or more of the cassettes may comprise total pressure increasing means.

Preferably, one or more of the cassettes may comprise one or more fluid interaction components adapted to perform one or more chemical unitary operations.

Preferably, one or more of the cassettes may comprise a socket adapted to house the fluid interaction component.

Preferably, one or more of the cassettes may be adapted to maintain and/or provide a three dimensional flow in at least a part of the flow passage.

One or more of the cassettes may preferably comprise an inlet where fluid flows into the cassette and an outlet where fluid flows out of the cassette, the inlet and outlet being connected to the flow passage.

One or more of the cassettes may preferably comprise or be adapted to receive a velocity inducer, the velocity inducer constituting preferably at least a part of the flow passage. When the velocity inducer constitutes at least a part of the flow passage, an interaction introducing passage may preferably be located upstream or downstream of the velocity inducer in the cassette. The velocity inducer may preferably be adapted to receive fluid at one velocity and deliver the fluid at a higher velocity. Furthermore, the velocity inducer may preferably be adapted to pump fluid through the cassette. Alternatively or in combination therewith, the velocity inducer may preferably be adapted to receive fluid in one direction and deliver the fluid in another direction.

In preferred embodiments, a fluid processing unit may preferably comprise at least two, such as at least three, preferably at least four interaction introducing passages. In still further preferred embodiments, at least two of the interaction introducing passages may preferably be similar such as identical to each other. Alternatively or in combination therewith, all interaction introducing passages may be identical.

One or more of the cassettes may preferably comprise at least one interaction introducing passage comprised in the flow passage; the socket may preferably extends into the interaction introducing passage so that when an fluid interaction component is present in the socket, the fluid flowing through the interaction introducing passage interacts with the fluid interaction component. Preferably, one or more of the flow passages may preferably comprise a first cavity and a second cavity being in fluid communication via the interaction introducing passage connecting the first and the second cavity so that fluid may flow from the first cavity through the interaction introducing passage and to the second cavity. Preferably, a velocity inducer, such as an impeller, may be arranged upstream of the first cavity.

Preferably, the shape of the interaction introducing passage(s) may provide an acceleration of the fluid through the interaction introduction passage.

Preferably, the first and the second cavities may be arranged so fluid may only flow from the first cavity to the second through the interaction introducing passage.

In preferred embodiments, one or more of the cassettes may comprise a closable re-circulation channel for re-circulating at least a part of fluid from a position downstream of a fluid interaction component to a position upstream of a fluid interaction component.

Preferably, one or more fluid interaction components may be arranged in a socket.

The outer housing of one or more of the cassettes may be adapted to be pressure carrying.

One or more of the cassettes may preferably comprise means for agitating the fluid flowing through the cassettes.

In preferred embodiments, one or more of the cassettes may preferably comprise a wall element arranged perpendicular to a flow direction through the cassette defined as the direction extending from inflow to outflow of the cassette. The wall element preferably comprises one or more penetrations through which the fluid flow inside the cassettes. These directions preferably refer to embodiments wherein the inflow and outflow takes place around a longitudinal axis of the fluid treatment unit. In alternative embodiments, the inflow and/or the outflow are offset with respect to a longitudinal axis of the fluid treatment unit, but the orientation of the wall element will preferably still be perpendicular to the longitudinal axis of the fluid treatment unit.

The casing or at least a part thereof may preferably be thermally insolated. Alternatively or in combination therewith, the casing or at least a part thereof may preferably comprise a cooling and/or heating jacket.

A fluid processing unit according to the present invention may preferably comprise a fluid collector for collecting fluid leaking from the processing unit.

At least one of the cassettes may preferably be made from different materials. Alternatively or in combination therewith, at least one of the cassettes may be made from a single material. In some preferred embodiments, all the cassettes may each be made from different materials. The material(s) of the cassettes may preferably be selected from metal, composite materials, coated material, plastic, ceramics or combinations thereof.

A processing unit according to the present may preferably comprise one or more valves arranged to control the flow in and/or out of the processing unit.

In preferred embodiments, the unit may have a longitudinal extension and the fluid processing unit may preferably comprise means for fixating the cassettes in a direction being perpendicular to the longitudinal direction. Pressure in a direction being perpendicular to the longitudinal direction may preferably be balanced by o-rings to provide a fluid tight sealing.

When the unit has a longitudinal extension, the unit may preferably comprise stays, preferably in the form of stay bolts extending in the direction of the longitudinal extension, the stay being arranged to balance pressure in the unit in longitudinal direction.

Units according to the present invention may preferably comprise an energy source for providing energy to energy demanding means, such as total pressure increasing means and/or velocity inducers, inside the fluid processing unit. Preferably, the energy source may comprise an electrically driven motor.

A unit according to preferred embodiments of the invention may comprise a shaft extending through two or more, such as all, of the cassettes of the unit. Such a shaft may preferably extend outside the unit and may preferably be connected to a motor, preferably being an electrically driven motor arranged outside the unit.

One, some or all of the fluid interaction components may preferably comprise an electromagnetic radiation source, such as an UV light source. Alternatively or in combination therewith one, some or all of fluid interaction components may comprise one or more nozzles. Furthermore, one, some or all of the fluid interaction components may alternatively or in combination therewith comprise one or more process active surfaces, such as one or more filter surfaces for filtering fluid, one or more catalytic surfaces for providing a catalytic process, one or more heat exchanger surfaces, one or more absorber surfaces, one or more condenser surfaces, one or more stripper surface, one or drying surfaces, one or more surfaces for carrying biological growth, one or more surfaces for crystallization, one or more surfaces for ion exchanging, one or more membrane surfaces or combination thereof. In still further preferred embodiments, one, some or all of the fluid interaction components may alternatively or in combination comprise surfaces for establishing an electromagnetic field so as to perform an electrolytic process, electro-dialytic process, electro de-ionization process or combinations thereof. Furthermore or alternatively, one, some or all of the fluid interaction components may preferably comprise means for exposing fluid to radiation such as magnetic radiation, ultraviolet radiation, radioactive radiation, ultra sound, microwaves, laser radiation or combinations thereof.

In combination with the above or alternatively, one, some or all of the fluid interaction component may preferably comprise a separator, a centrifuge, means for milling, means for homogenization, a decanter, a transporter for transporting e.g. particles, ion exchanging substances, a mixer or combinations thereof.

In still further embodiments one, some or all of the fluid interaction components may alternatively or in combination with the above preferably comprise dosing means, means for degassing, distillation, aeration, such as atmospheric air, oxygen, ozone, chlorine, means for evaporation, means for reducing the pressure e.g. for vacuum distillation, means for steam treatment or combinations thereof.

A fluid processing unit according the present invention may preferably comprise one or more elements adapted to provide the fluid a given retention time in a cavity.

A fluid processing unit according the present invention may preferably comprise a reactor for performing a biological process, a chemical process, a fuel cell process or a combination thereof.

One, some or all of the fluid interaction components may preferably comprise a heat source, such as an electrical heater.

A unit according to the present invention may preferably comprise means for rotating elements, such as impellers, within the unit. Preferably, the means for rotating elements may comprise one or more gears. Alternatively or in combination therewith, the means for rotating elements may preferably comprise one or more couplings means, such as mechanical coupling means, magnetic coupling means, viscous friction coupling means, inductive coupling means or combinations thereof. Preferably, the element is a part of an electromotor or generator.

Preferred embodiments of processing units according to the present invention may preferably comprise a turbine encapsulated by the casing. Alternatively or in combination therewith, the processing unit may preferably comprise a displacement pump encapsulated by the casing.

In embodiments comprising socket(s), one or more of the sockets may preferably be adapted to house one or more fluid interaction components in a releasable manner so that the fluid interaction component(s) may be reversibly removed from and inserted into the socket.

Cassettes according to preferred embodiments may preferably be stackable.

One, more or all of the fluid interaction components may alternatively or in combination with the above fluid interaction components preferably comprise a pressure sensor, a temperature sensor, a fluid velocity sensor, a mass flow sensor, a volumetric flow sensor, a pH-sensor, a conductivity sensor, an organic content sensor, a capacitance sensor, a turbidity sensor, a radiation sensor, a spectrometric sensor or combinations thereof.

In preferred embodiments of fluid processing units, a unit may preferably comprise a plurality of cassettes with individually different fluid interaction components.

In a second aspect, the present invention relates to a cassette preferably comprising an outer housing being arranged so that the outer housing forms at least a part of a casing of a fluid processing unit when at least two cassettes are combined to form at least a part of the fluid processing unit, the cassette further comprising a flow passage through the cassette and the cassette further comprising or being adapted to receive at least one fluid interaction component.

A cassette according to the second aspect of the invention may comprise one or more of the features disclosed in connection with the first aspect of the invention.

The total pressure increasing means may in preferred embodiments be adapted to increase the total pressure of the fluid(s) flowing through the unit, so that the fluid(s) leaving the unit has (have) a higher total pressure than when the fluid(s) flows into the unit.

In a third aspect, the present invention relates to a method for providing an interaction between a fluid and an interaction component, the method comprising feeding fluid to a fluid processing unit according to the first aspect of the invention.

The invention and in particular preferred embodiments thereof will now be disclosed in greater details in connection with the accompanying figures in which

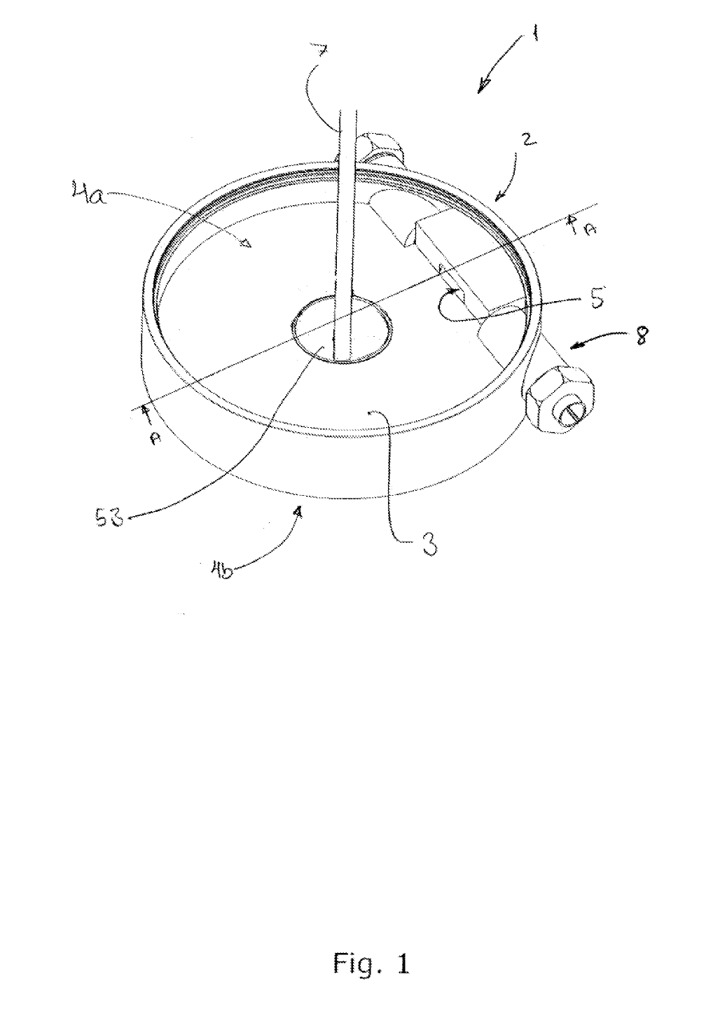

FIG. 1 shows a three dimensional view of a first embodiment of a cassette as seen from the inflow side.

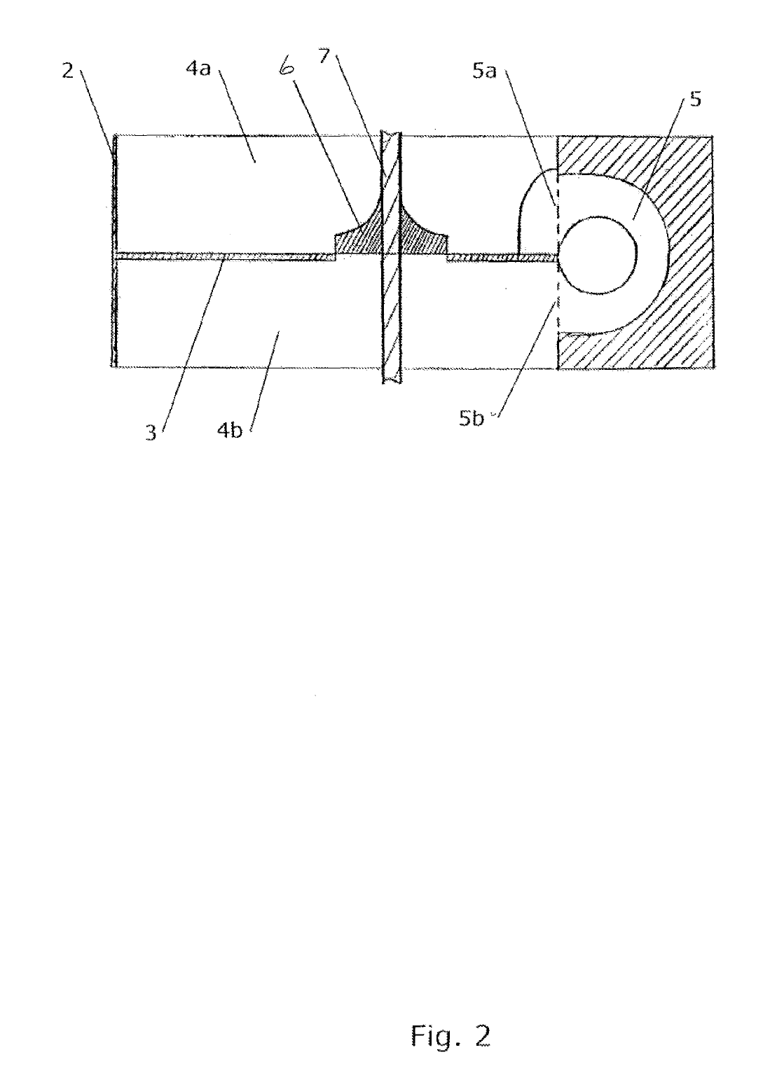

FIG. 2 shows schematically a cross sectional view along line A-A of the embodiment shown in FIG. 1,

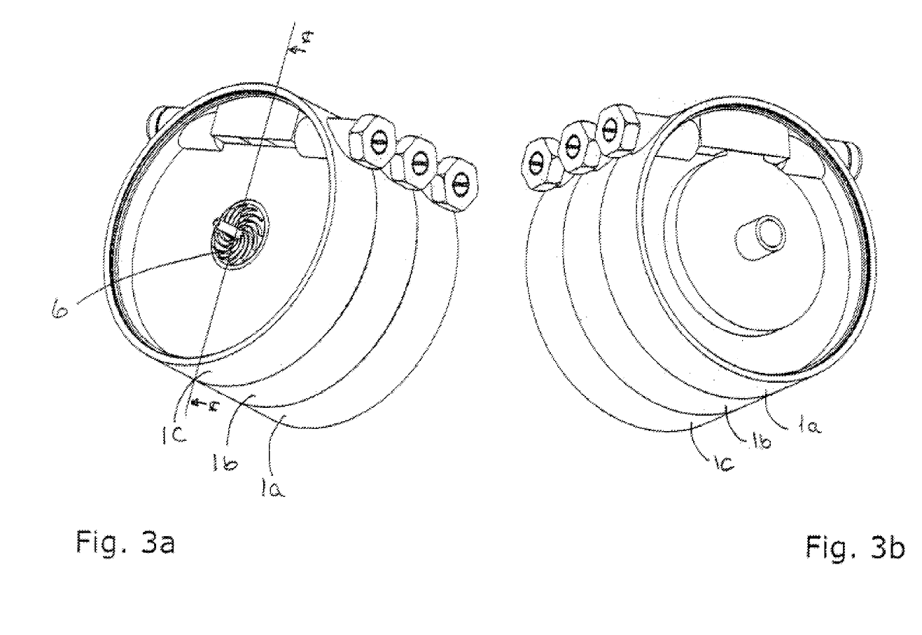

FIG. 3 shows a preferred embodiment of a stack of three cassettes for exposing fluid to electromagnetic radiation; the device comprises a stack of three cassettes shown in FIG. 1 and FIG. 3a shows the stack of cassettes from an inflow side and FIG. 3b shows the stack of cassettes from an outflow side,

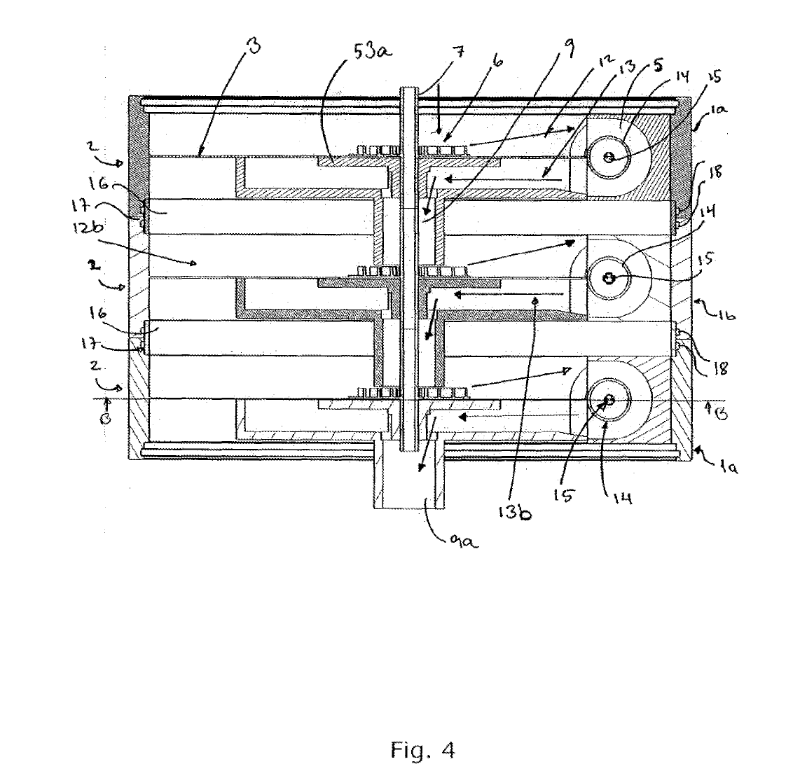

FIG. 4 shows schematically a longitudinal cross sectional view along line A-A of the fluid processing device disclosed in FIG. 3,

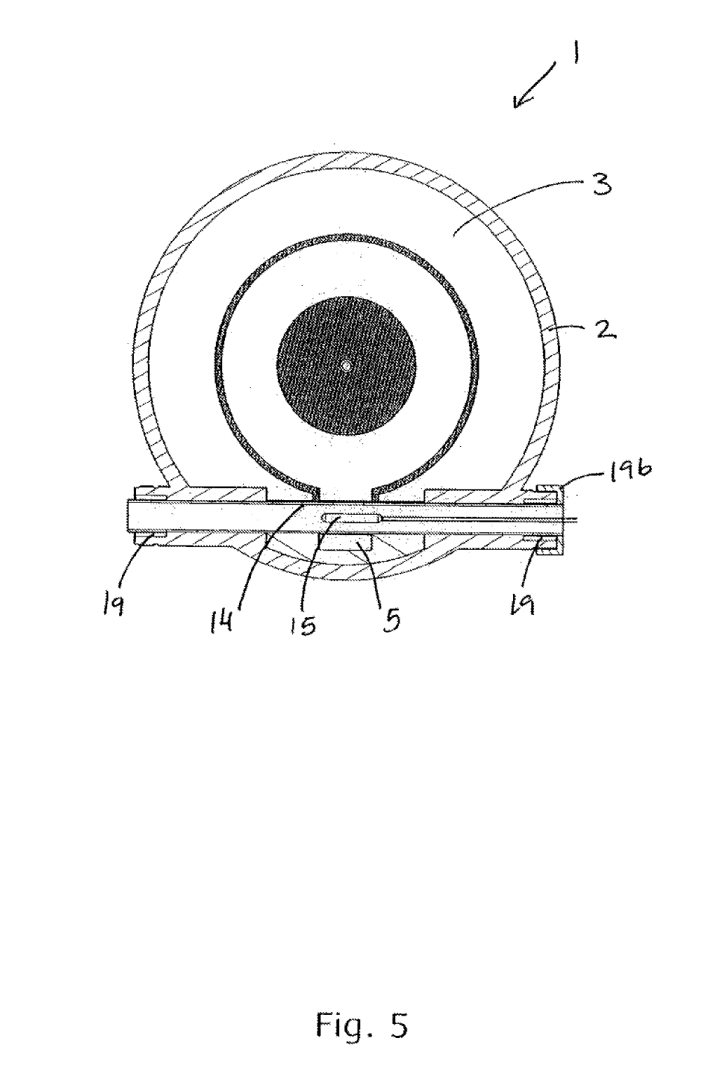

FIG. 5 shows a horizontal cross sectional view taken along line B-B of the embodiment shown in FIG. 4,

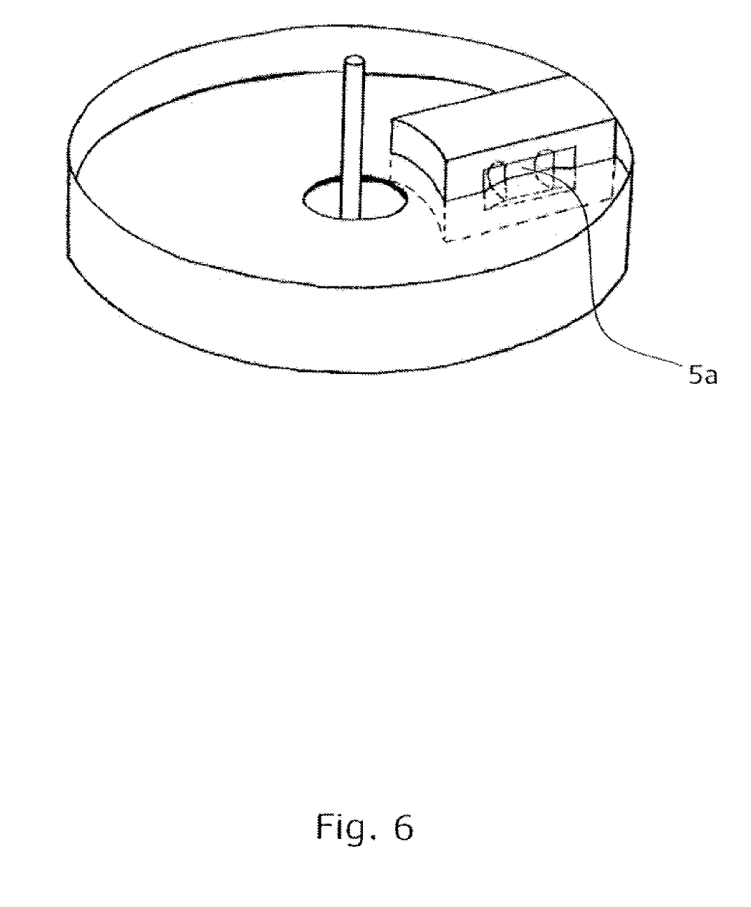

FIG. 6 shows schematically a further preferred embodiment of a cassette according to the present invention wherein the fluid interaction component is arranged radially,

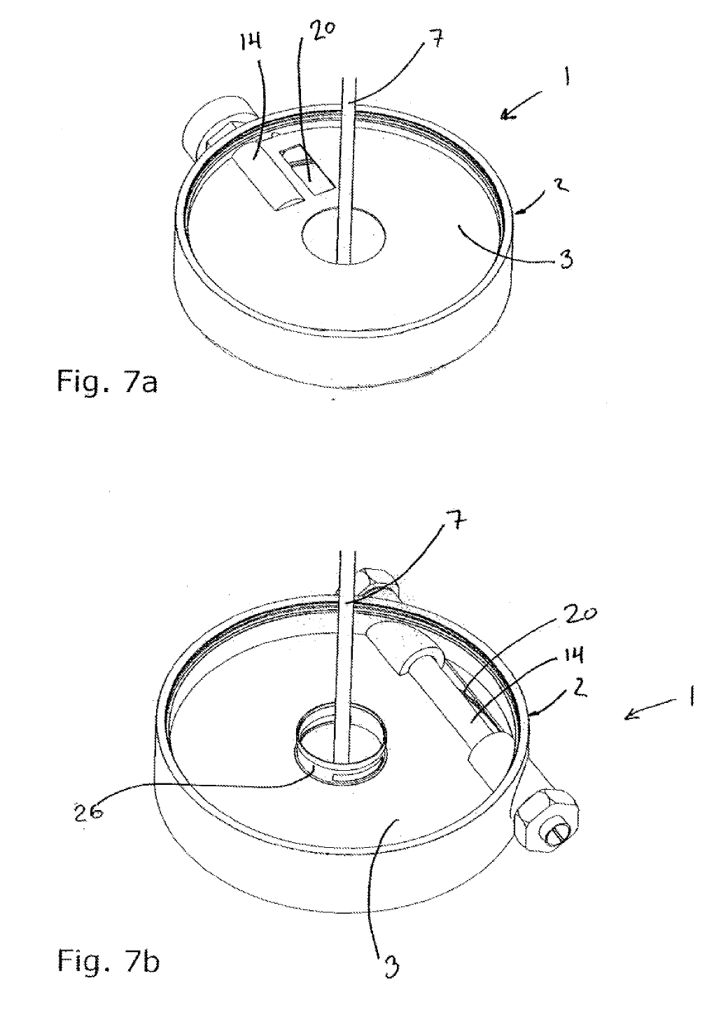

FIG. 7 shows schematically two further preferred embodiment of a cassette according to the present invention wherein the interaction introducing passage is a penetration provided in the wall element,

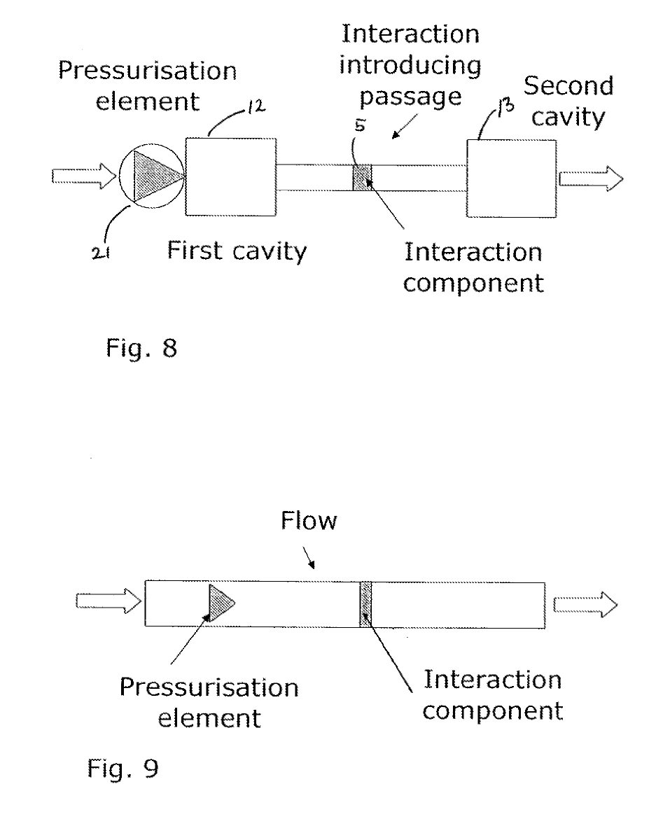

FIG. 8 shows schematically a flow passage in an embodiment of a cassette according to the present invention,

FIG. 9 shows schematically a flow passage in another embodiment of a cassette according to the present invention,

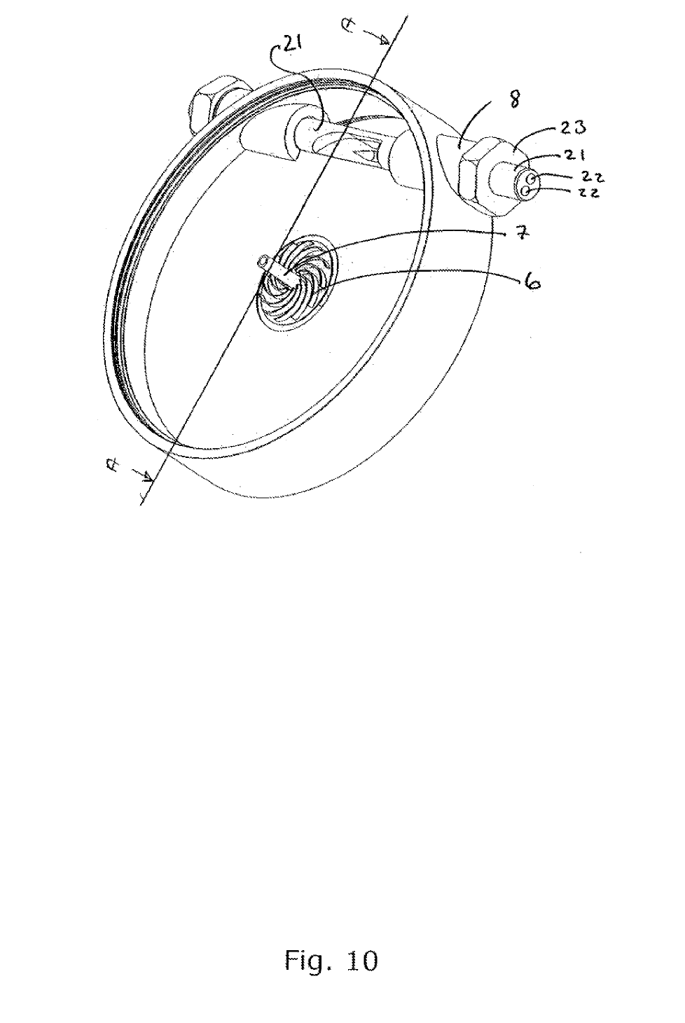

FIG. 10 shows a three-dimensional view of a cassette of a processing unit according to the present invention; the cassette is adapted to dose one or more substances to the fluid flowing through the cassette,

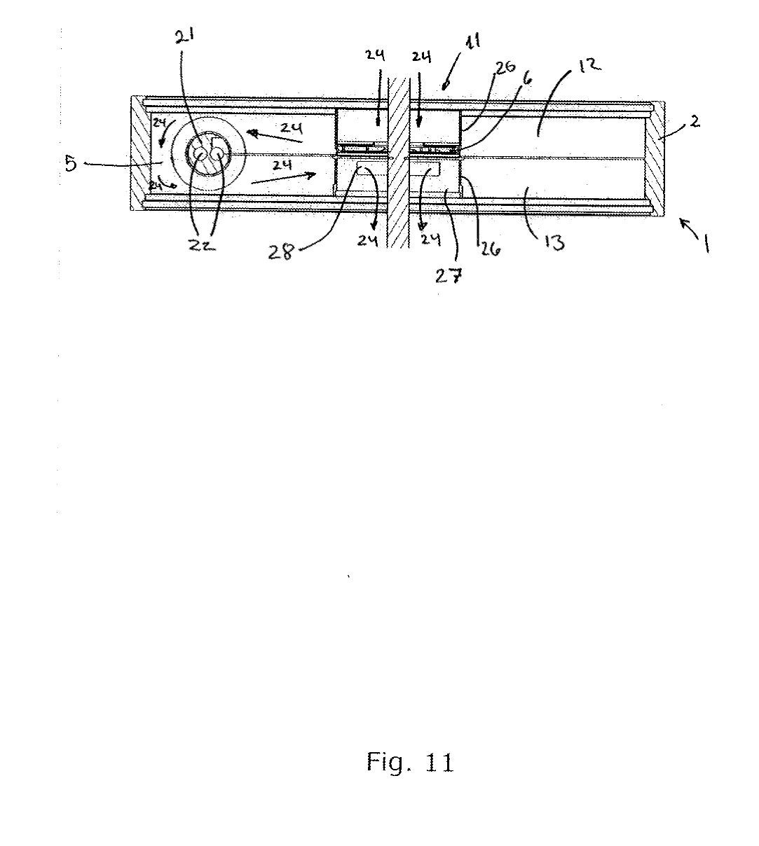

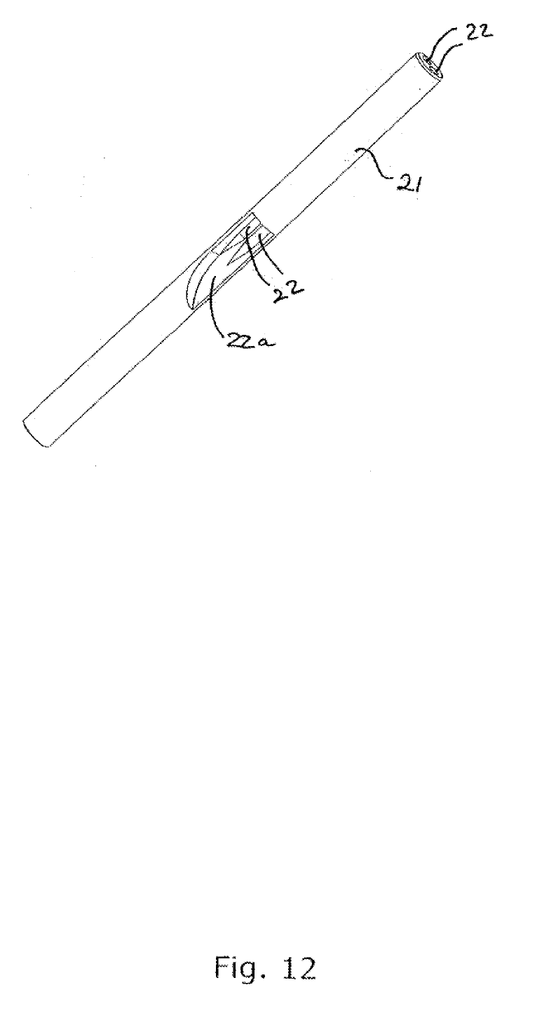

FIG. 11 shows a cross section of the cassette shown in FIG. 10 along line A-A in FIG. 10,

FIG. 12 shows the fluid interaction component in the form of a dosing unit of the cassette shown in FIG. 10,

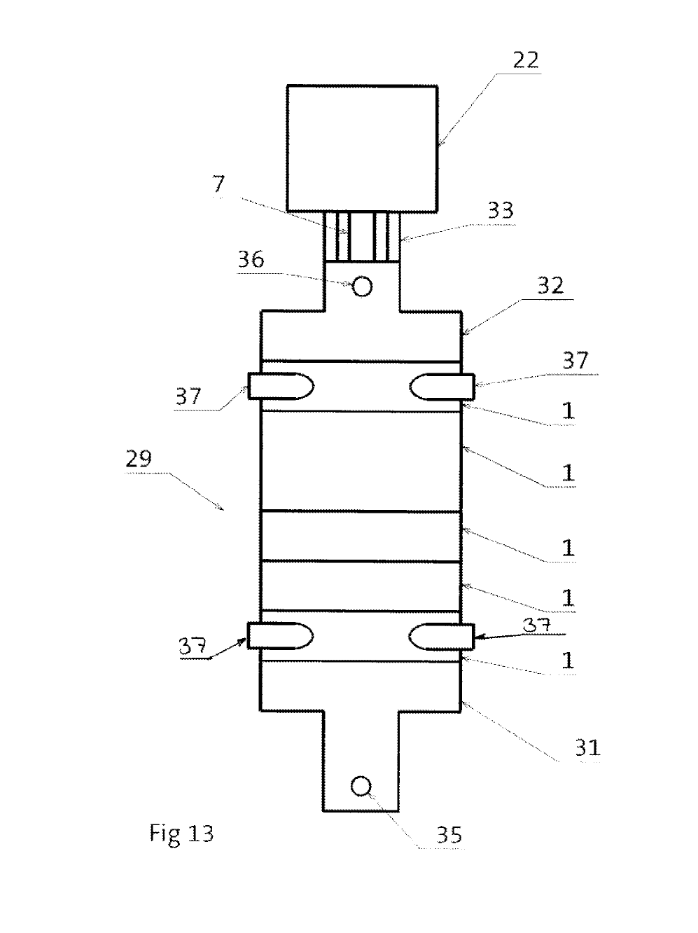

FIG. 13 shows schematically a processing unit according to the present invention; the unit comprises five cassettes, an inlet element, an outlet element and a motor for rotating impellers arranged in the processing unit,

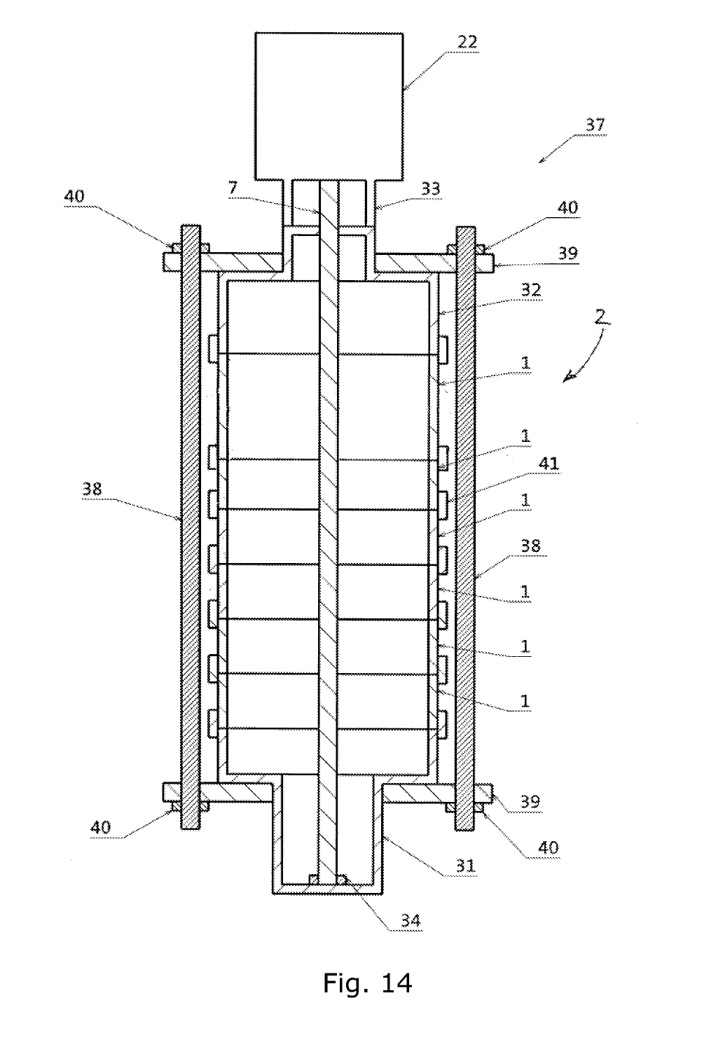

FIG. 14 shows schematically a longitudinal cross section of a processing unit according to the present invention. The unit comprises six cassettes, an inlet element, an outlet element and a motor for rotating impellers arranged in the processing unit. FIG. 14 shows in particular an embodiment of assembling the unit shown in FIG. 13; fluid interaction components as well as the flow passages are not shown in the figure,

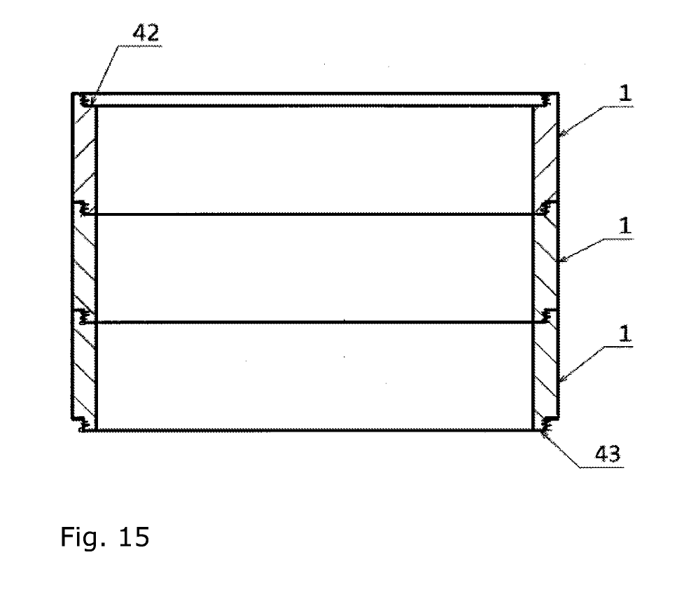

FIG. 15 shows schematically a longitudinal cross section of three cassettes according to the present invention assembled by threads being provided on a part of the cassettes' outer housing,

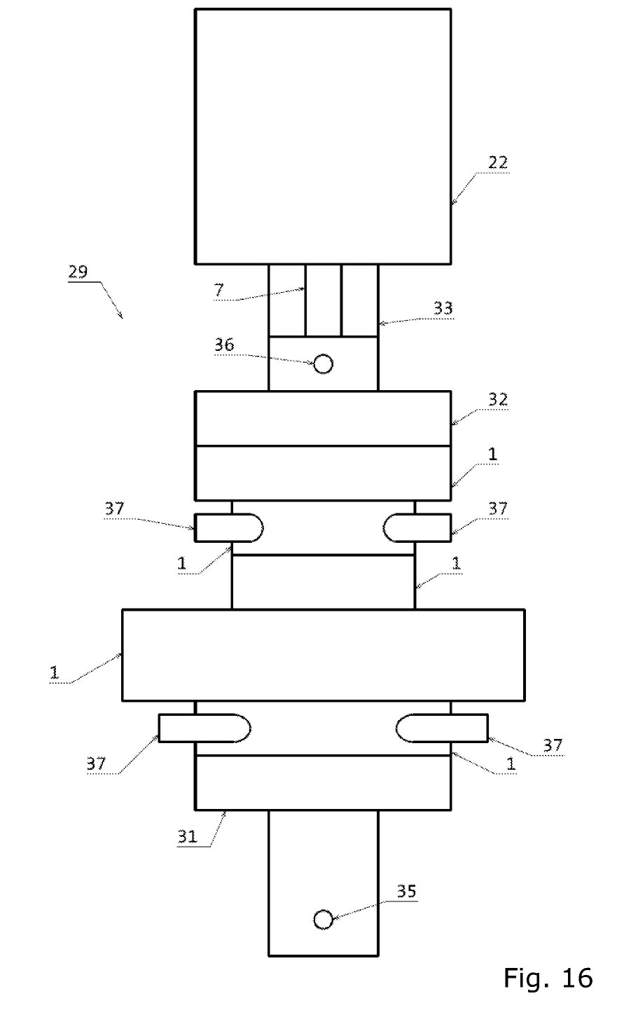

FIG. 16 shows schematically a processing unit according to the present invention. The unit comprises five cassettes with various outer geometries, an inlet element, an outlet element and a motor for rotating impellers arranged in the processing unit,

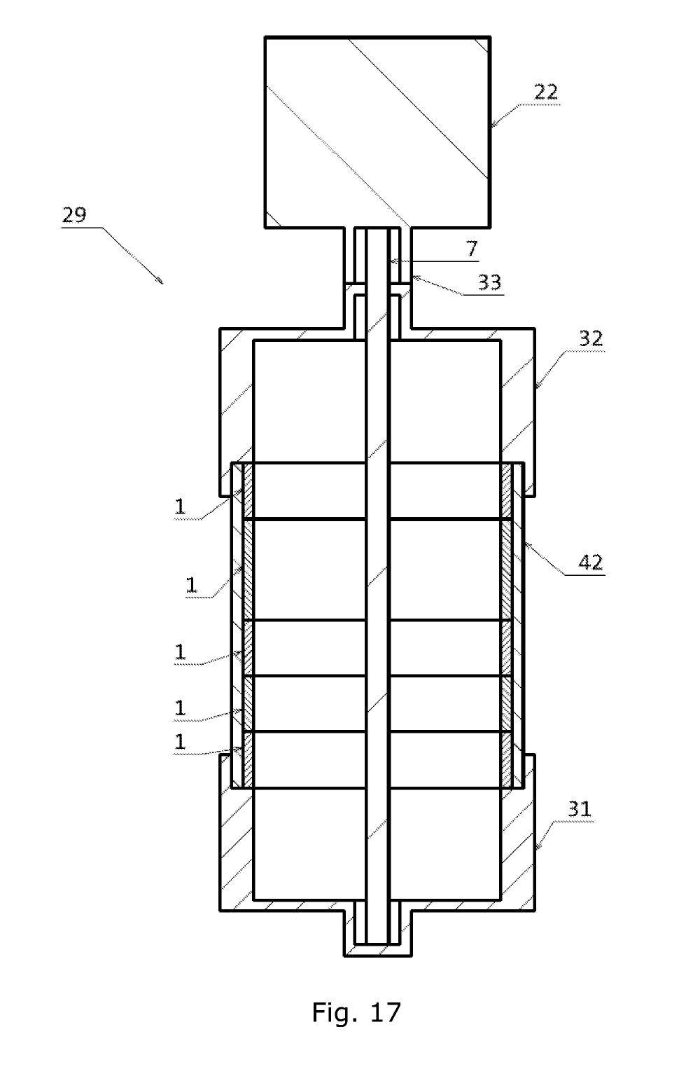

FIG. 17 shows schematically a longitudinal cross section of a processing unit according to the present invention comprising five cassettes, an inlet element, an outlet element, a motor for rotating impellers (not shown) arranged in the processing unit; fluid interaction components as well as the flow passages are not shown in the figure,

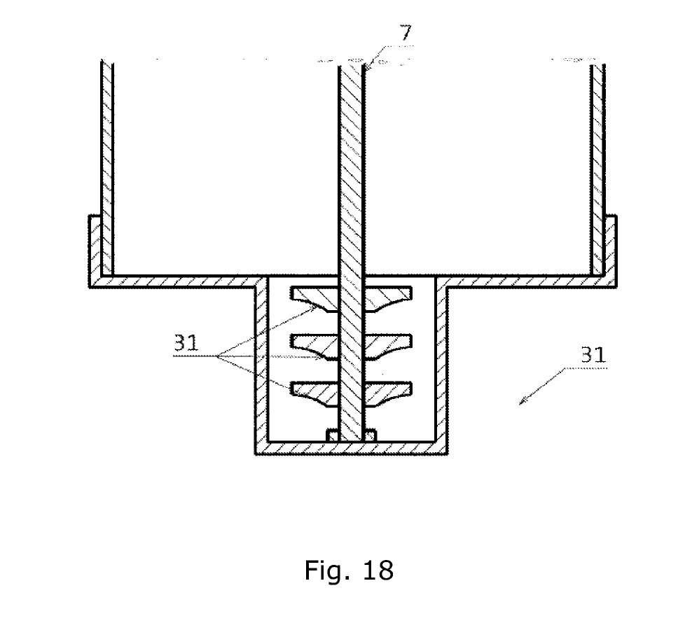

FIG. 18 shows a part of the embodiment of FIG. 13 further comprising a pressure increasing step,

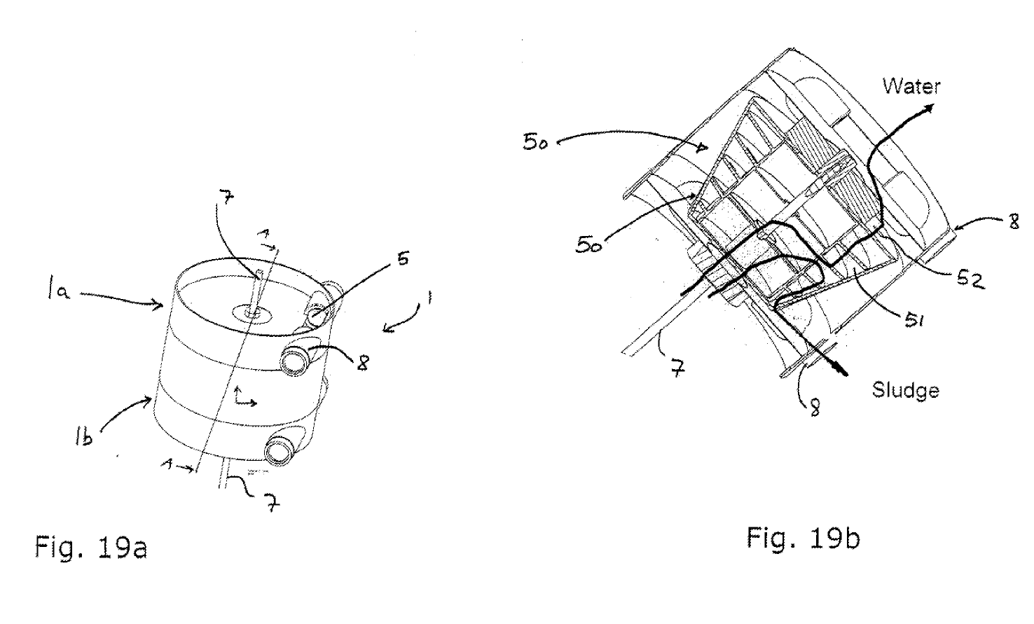

FIG. 19 shows a preferred embodiment of a cassette comprising a decanter for separating e.g. water from sludge; FIG. 19a shows a three-dimensional view of the cassette and FIG. 19b shows a cross sectional view along line A-A in FIG. 19a,

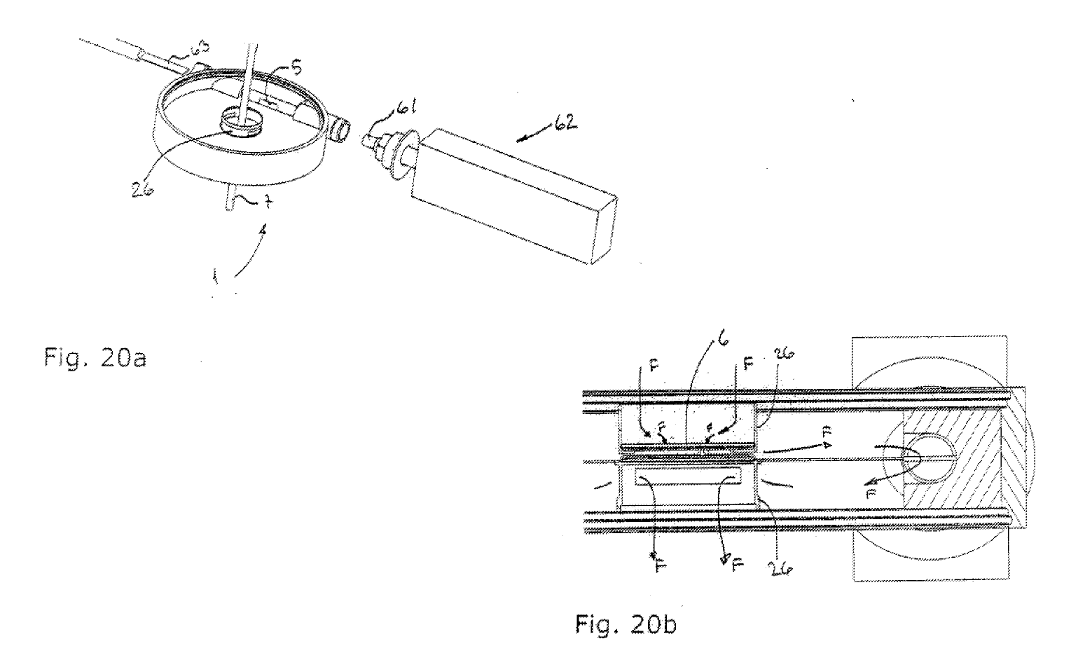

FIG. 20 shows schematically a preferred embodiment of a cassette; FIG. 20a shows the cassette in a partly exploded view and FIG. 20b shows a segment of a cross sectional view taken along a radius of the cassette,

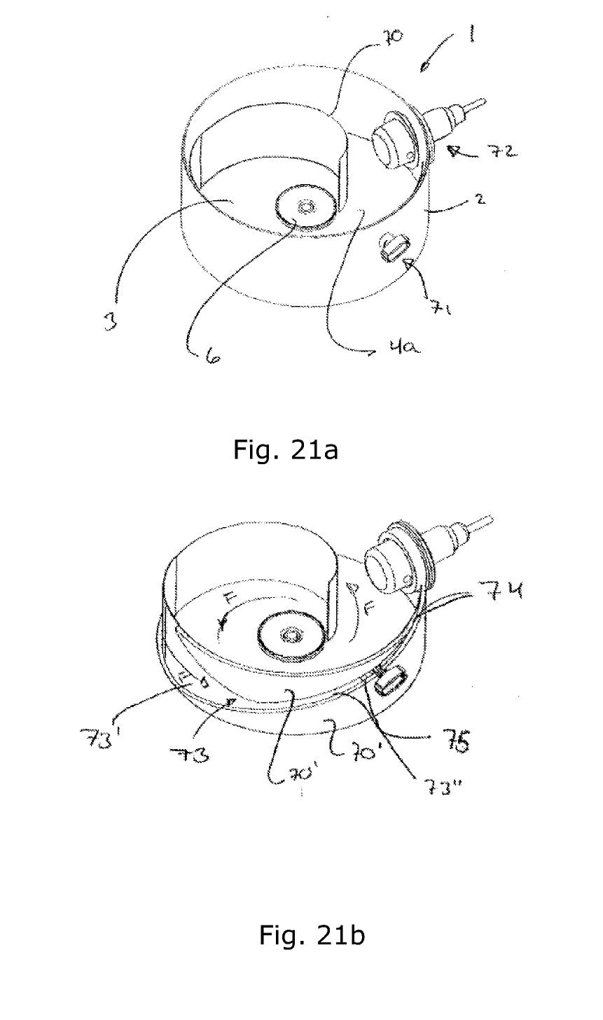

FIG. 21 shows schematically a preferred embodiment of a cassette adapted to carrying out measurements on a fluid flowing through the cassette; FIG. 21 shows the cassette in a 3-dimensional view.

### DETAILED DESCRIPTION OF PREFERRED EMBODIMENTS OF THE PRESENT INVENTION

FIG. 1 shows a first embodiment of a cassette 1 of a fluid processing unit; in FIG. 1 the cassette 1 is shown from the inflow side. In the present context “inflow side” refers to the side facing upstream a main inflow direction and “outflow side” refers to the side facing downstream a main outflow direction. FIG. 2 shows a cross sectional view along line A-A in FIG. 1. It should be mentioned that although the cassette 1 is shown as a circular shaped element with the radial extension being substantially larger than the height of the element 1, many other geometrical shapes are possible within the scope of the present invention.

The cassette 1 comprises a cylindrical outer housing 2 in the form of a cylindrically shaped wall and a wall element 3 which in common defines two cavities 4a and 4b inside the cassette 1. In the embodiment shown in FIG. 2, one cavity 4a is located above the wall element 3, and one cavity 4b is located below the wall element 3.

The cassette 1 further comprises an interaction introducing passage 5 connecting the two cavities 4a and 4b with each other so that fluid may flow from the cavity 4a through the interaction introducing passage 5 and to the cavity 4b. In the embodiment shown, the outer housing 2, the wall element 3 and the interaction introducing passage 5 define a flow passage for the fluid, so that the fluid can only flow from cavity 4a to cavity 4b through the interaction introducing passage 5.

The interaction introducing passage shown in FIG. 2 has a rectangular-shaped inlet 5a and outlet 5b; the inlet 5a and outlet 5b are indicated in FIG. 2 with dotted lines.

Although the interaction introducing passage 5 in the flow direction in FIG. 2 is shown as extending from inlet 5a to outlet 5b, this may not always be the case. In general the interaction introduction passage 5 may be defined as a flow passage in which the fluid interaction component is placed and thereby the passage in which the fluid interaction is being introduced. The actual interaction may continue both up- and down-stream of the passage.

The fluid flows through the cassette 1 under the influence of a fluid velocity inducer which in the embodiment of FIG. 1 is an impeller 6 rotated by a shaft 7 connected to a motor (the impeller is not shown in FIG. 1 but in FIG. 2). Various shields covering the blades of the impeller 6 and guiding fluid from an inlet and towards the impeller as well as and covers covering the cavities 4a, 4b are not shown in FIGS. 1 and 2 in order to render the interior of the cassette 1 and in particular the interaction introducing passage 5 visible—instead further details are presented in relation to e.g. FIG. 4. Thus, fluid flowing through the cassette 1 shown in FIGS. 1 and 2 flows through the impeller 6, through cavity 4a, through interaction introducing passage 5, through cavity 4b and out of the cassette 1.

A centrally arranged bore 53 may be arranged in wall element leaving space for the shaft 7 to extend through cassette and to a number of consecutively arranged cassettes. The centrally arranged bore 53 may be covered by the element labeled 53a in FIG. 4 to support the impeller 6 and seal the bore to avoid fluid from flowing through the bore.

The impeller 6 is used to pump the fluid through the cassette 1. Furthermore, the impeller 6 may be used to pump the fluid through one or more additional cassettes which do/does not have impellers 6. The fluid enters the impeller 6 in a direction parallel to the shaft 7 and leaves the impeller 6 mainly in a direction being perpendicular to this direction. The fluid leaves the impeller 6 in a rotational manner meaning that the fluid has a radial as well as a tangential velocity component.

Thus, the cassette 1 comprises a flow passage in which the fluid flows through the cassette 1. In the embodiment shown in FIG. 1, the flow passage comprises the flow path through the impeller 6, the flow path through the cavity 4a, the flow path through the interaction introducing passage 5 and the flow path through the cavity 4b.

In alternative embodiments (not illustrated) of cassettes, a fluid guide is present instead of the impeller. Such a fluid guide typically comprises one or more guide blade(s) turning the flow of fluid from a direction parallel to outer housing to a direction perpendicular to this direction and towards the interaction introducing passage. The fluid guide may introduce a tangential component to the fluid.

The cassette 1 may further comprises a socket 8 which in the embodiment shown in FIG. 1 comprises a channel extending from the interaction introducing passage 5 to the exterior of the cassette 1; the exterior is in the embodiment shown in FIG. 1 outside the housing 2. The socket 8 is adapted to receive or comprises an fluid interaction component which may be e.g. an UV-lamp for exposing the fluid to UV light, a nozzle for dosing one or more substance(s) to fluid flowing through the interaction introducing passage 5 and/or other types of processing sources. Although the socket 8 may comprise a fixture (not shown) for fixating the processing source, such fixation may be provided by other means not necessarily being a part of the socket 8.

The socket 8 may or may not be fluid-tightly sealed from the interaction introducing passage 5 depending on the type of interaction to take place. For instance, if the interaction to take place is to expose the fluid to UV light, the socket 8 is preferably made as a UV light penetrable tube with its interior being fluid-tightly sealed off from the interaction introducing passage 5 and the source of UV light arranged inside the tube; such an embodiment will be disclosed in greater details below. If the interaction to take place is to dose one or more substances into the fluid via a nozzle, the socket 8 may be a channel opening into the interaction introducing passage 5 and the nozzle may be arranged in the socket 8 so as to dose the substance(s) into the fluid flowing through the interaction introducing passage 5. The socket 8 and the corresponding fluid interaction component are preferably shaped so that the fluid can not flow from the interaction introducing passage 5 to the exterior through the socket 8. This may be e.g. be provided by an end cap (not shown) arranged on an exterior end of the socket 8.

A cassette 1 may comprise more than one socket 8. For instance, one socket may be a tube sealed from the interaction introducing passage, and the other socket may be a channel opening into the interaction introducing passage.

In a further embodiment, the cassette 1 comprises a closable re-circulation channel (not shown) connecting the first and the second cavity 4a,4b to allow fluid to flow from the first to the second cavity without passing through the interaction introducing passage 5. Such a re-circulation channel may e.g. be provided by penetrations in the outer housing 2 connected with each other by a pipe connection including a shut-off valve leading fluid through penetrations in the outer wall 2 between the two cavities 4a and 4b. Such a re-circulation channel may be used if e.g. the interaction introducing passage 5 becomes clogged or only a fraction of the fluid is to flow through the interaction introducing passage 5.

Alternatively, the re-circulation channel may be provided by a valve arranged in the wall element 3.

Cassettes 1 are preferably designed to be combined to form at least a part of a processing unit. In particularly preferred embodiments, the cassettes 1 are combined by stacking, and each cassette 1 acts as a processing stage so that a device may comprise a number of processing stages each either performing the same processing or different processings. An embodiment with three UV processing stages is shown in FIG. 3.

FIG. 3 shows a part of a processing unit with three cassettes 1a, 1b, 1c acting as three processing stages—FIG. 3a shows the stack of cassettes from an inflow side and FIG. 3b shows the stack of cassettes from an outflow side. The cassettes 1 in FIG. 3 are shown as identical although this is not necessarily a requirement according to the present invention. On the contrary, the actual number of cassettes 1 may be varied and the cassettes may not always be similar to each other.

With reference to FIG. 4 showing a cross sectional view of the cassettes shown in FIG. 3, each cassette 1a, 1b, 1c, comprises an impeller 6, a cassette connecting passage 9, and an interaction introducing passage 5. In the embodiment shown in FIG. 3, the impellers 6 are rotating impellers 6 receiving fluid in an axial direction through cassette connecting passage 9 and delivering fluid at a higher velocity in radial direction as indicated by arrows labeled 10 in FIG. 4.

Each processing stage further comprises two cavities 12, 13 (similar to cavities 4a and 4b of FIG. 1) divided by each other by a wall element 3 and being in fluid communication with each other through the interaction introducing passage 5. The interaction introducing passage 5 is formed as a passage leading fluid e.g. from cavity 12b to 13b. Passage 9a form an outlet of the cassette 1a.

A part of the wall of the interaction introducing passage 5 is formed by a shield 14 behind which a radiation source 15 is arranged. In the preferred embodiment shown in FIG. 1, the radiation source is an UV radiation source, such as an UV lamp. The shield 14 is transparent for the radiation to allow the fluid to be exposed to the radiation emitted from the source.

An impeller shaft 7 is provided for rotating all impellers in common, and the impeller shaft 7 is connected to a motor (not shown) typically arranged above an outlet 36. Thus, when activating the motor, the impellers 6 are rotating whereby fluid is drawn into the combined cassettes 1 through the inlet 11. The fluid flows through the impeller 6 into the cavity 12 and through the interaction introducing passage 5 where the fluid is exposed to radiation from the radiation source 15, where after the fluid flows into the cavity 13 towards the next impeller 6.

As indicated in FIGS. 3 and 4, the stack of combined cassettes 1 may be modular so that a number of processing stages can be applied. As the cassettes 1 are stackable, a particular processing unit may easily be configured to meet different demands.

Combining of cassettes may be accomplished by stacking the outer housings 2 of the cassettes 1 upon each other and assembling the cassettes 1 to each other by assembling rings 16 arranged in grooves 17 provided in outer housings 2 of the cassettes 1 as shown in FIG. 4. In order to keep the cassettes 1 assembled when pressure is applied to the interior of the cassettes 1, the cassettes 1 are maintained in their mutual relationship by e.g. stays (not show) extending in the stacking direction of the cassettes 1 (vertically with relation to FIG. 4) clamping all the cassettes 1 together. Sealing of the outer housing 2 to withstand a difference in pressure between the interior and exterior of the cassettes 1 is done by the O-rings 18 shown in FIG. 4.

FIG. 5 shows a horizontal cross sectional view taken along line B-B in FIG. 4. FIG. 5 shows in particular, the radiation source 15, the shield 14 and a cross section of the interaction introducing passage 5. All fluid passing through the cassette 1 is passing through the interaction introducing passage 5 and as it is indicated in FIG. 4, the dimensioning of the interaction introducing passage 5 is so that the fluid gets in close contact with the source of radiation.

FIG. 5 also indicates that the shield 14 is sealed to the cassette 1 by seals 19 and secured to the device 1 by a screwed cap 19b so that fluid cannot flow to the interior of the shield 14. Thereby the radiation source 15 can be replaceably arranged within the shield 14 so that replacement of the radiation source 15 can be provided without dismantling the whole cassette 1.

FIG. 6 shows schematically a further embodiment of a cassette 1 according to the present invention. In this embodiment the inlet 5a and the outlet 5b (5b not indicated in the figure) are arranged parallel to a radius of the cassette 1. Similar to the embodiment shown in FIG. 1, the cassette 1 comprises a socket 8 (not visible) for receiving a processing source; the source is not shown in the figure.

FIGS. 7a and 7b shows further embodiments of cassettes according to the present invention. The cassettes shown in these figures also comprise an outer housing 2 and a wall element 3. However, in these embodiments the interaction introducing passage 5 is defined by a penetration 20 provided in the wall element 3. The figures show configurations where a shield in the form of a tube 14 is provided for housing e.g. a UV-source similar to the shield shown in FIG. 5.

FIG. 7a shows the cassette from an inflow side (the fluid flows through the penetration 20 downwardly with respect to the orientation of the figure) and FIG. 7a shows the cassette from an outflow side (the fluid flows through the penetration upwardly with respect to the orientation of the figure). FIG. 7b also shows a guide element 26 arranged to guide the fluid through the impeller (see also FIG. 11).

It should be mentioned that although the embodiments shown in FIGS. 1-7 are shown to comprise one interaction introducing passage 5, more than one interaction introducing passage 5 may be provided in the cassettes 1. Furthermore, the mutual orientation of the interaction introducing passages 5 may be varied, e.g. two or more interaction introducing passages may be orientated similar to each other or different to each other.

In some embodiments, the fluid interaction component of a cassette is an integral part of the cassette in the sense that it is non-removable, and in other embodiments the cassettes are provided with a socket that enables removal of the fluid interaction component. The latter embodiments are particularly useful in situations where for instance the fluid interaction component deteriorate during use, and/or in cases where the type of processing of the fluid is to be changed. This may be then be performed by only changing the fluid interaction component.

FIG. 8 shows schematically the flow passage in the cassette 1 of e.g. FIG. 1. As indicated in the figure, the cassette 1 comprises a pump 21 pumping fluid towards the first cavity 12 which is connected to the interaction introducing passage 5 being connected to the second cavity 13. As indicated in FIG. 1, the cross section of the interaction introducing passage 5 is smaller than the cross section of the cavities 12, 13 as seen from the fluid flowing from the first cavity 12 to the interaction introducing passage 5 and flowing from the interaction introducing passage 5 into the second cavity 13. Furthermore, the interaction introducing passage 5 is shown as having a longitudinal extension in downstream direction which is quite larger than the length of flow path in the cavities 12, 13.

However, the area of the cross section of the interaction introducing passage 5 and the extension thereof may be varied to meet a given requirement, and these sizes may be chosen so that the length of the interaction introducing passage 5 is shorter than the one shown in FIG. 8.

Furthermore, one or both of the cavities 12, 13 may in some embodiments not be present which is indicated in FIG. 9. It should be noted that in case processing does not take place through out the whole flow passage, the region upstream and the region downstream of the region in which processing takes place may be considered as cavities.

Following the disclosures put forward in connection with FIGS. 1-8, a cassette 1 according to the present invention may in accordance with preferred embodiments be considered as comprising a flow passage in which at least one interaction introducing passage 5 is present. The cassette 1 may further comprise a socket 8 adapted to receive an fluid interaction component, the socket 8 extending into the interaction introducing passage 5 so that when a fluid interaction component is present in the socket 8, the fluid flowing through the interaction introducing passage 5 interacts with the fluid interaction component. Such a cassette 1 may preferably comprise a fluid velocity inducer which may be passive or active. By passive is preferably meant an inducer which is not adding momentum to the fluid and by active is preferably meant an inducer which adds momentum to the fluid when flowing through the inducer—an active inducer is for instance an impeller.

Typically and preferably, a number of cassettes such as those disclosed in FIG. 8 are combined into a fluid processing unit wherein the cassettes are made as modules each comprising a flow passage leading fluid from an inlet to an outlet of each cassette in which flow passage an interaction introduction passage preferably is present. The fluid is preferably guided through the cassette by the velocity inducers and/or fluid guides in general where some may be assigned to overcome the pressure loss through the fluid processing unit (in some situations all inducers are assigned to this purpose) and some may be assigned to guide the fluid through an interaction introducing passage in a manner so that the interaction between the fluid and the fluid interaction component takes place in a selected way. It should be mentioned that the whole flow passage may be considered as an interaction introducing passage.

In still further embodiments, the processing of the fluid may be performed within the fluid guide such as in the impeller or velocity inducers.

FIGS. 10-12 show an embodiment of the invention wherein a cassette 1 is used to add one or more substances to the fluid. Such a substance may be a solid, a liquid or a gas. The substances will typically be added in precise doses which may be measured out by an external measuring unit (not shown). In the illustrated embodiment, the fluid interaction component is a dosing unit 21 having two substance channels 22 through which the substance(s) can be added to the fluid; the substance channels 22 of the dosing unit 22 open into a cut out 22a (see FIG. 12). The dosing unit 21 may either be an integral part of the cassette 1 or the dosing unit 21 may be arranged in a socket 8—in the embodiment shown in FIGS. 10-12 the dosing unit 21 is arranged in a socket 8. Although the dosing unit 21 is shown to have two substance channels 22, any number of substance channels 22 is possible within the scope of the invention. The substances to be added may be premixed and/or pre-heated/cooled, or the heating/cooling and/or mixing may take place in the processing unit.

FIG. 10 shows a three-dimensional view of a cassette similar to the cassettes of FIG. 4 with a centrally placed impeller 6 driven by a motor 22 (not shown) via a shaft 7. The cassette 1 is a part of a processing unit comprising further cassettes. The guide element 26 (see FIG. 11) is removed.

The dosing unit 21 is shown as fastened in the socket 8 by use of nuts 23, but it can be fastened by any suitable means well-known for a person skilled in the art. The substances are led to the inlet of the substance channels 22 e.g. via tubes. These tubes as well as the containers in which the substances are stored before use are not shown.

FIG. 11 is a cross-sectional view along line A-A in FIG. 10. The arrows 24 illustrate schematically the overall flow path of a fluid flowing through the cassette 1. A cylindrically shaped guide element 26 ensures that the fluid is guided from the inlet 11 of the cassette 1 towards the impeller 6 and subsequently to the first cavity 12 as well as from the second cavity 13 towards the outlet 27 of the cassette 1. The fluid passes the walls of the guide element 26 via guide holes 28 positioned to obtain a desired flow path.

In order to ensure that the substances and the fluid are sufficiently mixed for the specific purpose, the dosing unit 21 is designed to ensure that the substances are added to the whirl of the fluid. FIG. 11 shows the flow of substance from the first substance channel 22; the substance outlet from the second substance channel 22 is not visible in this figure but can be seen in FIG. 12. Since the substances are added in the whirl, a certain degree of mixing takes place before the substance containing fluid flows towards the second cavity 13 via the interaction introducing passage 5.

FIG. 12 shows a possible design of a dosing unit 21 with two substance channels 22. The area around the substance outlets of the substance channels 22 is designed to ensure that the substances are both added to the whirl of the fluid when it is in the first cavity 12.

It is possible within the scope of the present invention to have two or more cassettes 1 of the type used to add substances to the fluid stacked on top of each other. This may be done instead of or in combination with two or more substance channels 22 in each cassette 1. Use of stacked cassettes 1 of the same type may e.g. be advantageous or necessary if the substances are to be well-mixed with the fluid before being mixed or able to react with each other. Another reason could be that the substances should have significantly different temperatures when they are mixed with the fluid.

FIG. 13 shows schematically a processing unit 29 according to the present invention. The unit shown in FIG. 13 is formed as an elongated unit having cylindrical outer casing 30 and comprising five cassettes 1, an inlet element 31, an outlet element 32 and a motor 22. The motor 22 is arranged on a fixture 33. In the embodiment shown in FIG. 13 the casing comprises the outer housing of cassettes, the inlet element and the outlet element. Please note that the overall flow path is upwardly with reference to the orientation of the figure, meaning that e.g. the cassette configuration shown in fig. is turned upside down with reference to FIG. 4.

Within the cassettes a number of impellers 6 (see e.g. FIGS. 4, 10 and 11) are arranged which impellers 6 are arranged on a common shaft 7 extending from the motor 22 to a bearing 34 (see FIG. 14) arranged in the inlet element 31 so that when the motor 22 rotates, it rotates all the impellers 6.

Fluid enters into the processing unit 29 through the inlet 35 (see FIG. 13) provided in the inlet element 31, flows through the processing unit 29 an leaves the processing unit 29 through the outlet 36 (see FIG. 13) provided in the outlet element 32.

Two of the cassettes 1 comprise connections 37, such as sockets, housing fluid interaction components similar to the connections 37, such as sockets, disclosed in connection with FIGS. 1-12.

FIG. 14 shows schematically a longitudinal cross section of a processing unit 29 according to the present invention, and shows in particular one way of assembling the unit shown in FIG. 13. The unit is formed as an elongated unit having a cylindrical casing and comprises six cassettes 1, an inlet element 31, an outlet element 32 and a motor 22 arranged on a fixture 33 with a shaft 7 for rotating impellers (not shown) arranged in the processing unit 29. Fluid interaction components as well as the flow passages are not shown in the figure. The cassettes 1 may be in the form shown in the previous figures with corresponding descriptions. The outer walls of the inflow element and the outflow element are considered as part of the casing.

In the embodiment illustrated in FIG. 14, the cassettes 1 and elements 31, 32 are assembled by a processing unit assembling fixture 37 comprising a number of stay bolts 38 extending along the longitudinal direction of processing unit 29 and penetrating clamps 39. Nuts 40 are provided on the ends of the stay bolts 38 so that when the nuts 40 are tightened, the clamps 39 will provide a longitudinal force to the processing unit 29 so that the elements 31, 32 and cassettes 1 are held together in the longitudinal direction.

Securing of the elements 31, 32 and cassettes 1 in a direction perpendicular to the longitudinal direction of the processing unit 29 is shown as being provided by ring shaped guides 41 into which the elements 31, 32 and cassettes 1 fit snugly. Sealing of the processing unit is provided by applying o-rings e.g. in grooves provides in the ring shaped guides 41. Alternatively, or in combination thereto, the ring shaped guides 41 may be arranged inside the processing unit as shown in FIG. 4 (16, in FIG. 4).

FIG. 15 shows schematically a longitudinal cross section of three cassettes 1 according to the present invention assembled in an alternative manner. The cassettes 1 may e.g. be three of the cassettes shown in FIG. 13, however the method of assembling the cassettes may be used in other embodiments. Again, flow passages and fluid interaction components are not shown in the figure. The outer housings 2 of the cassettes 1 are provided with a recess 42 at one end and a projection 43 at the opposite end. In the recess 42 and on the projection 43 threads are provided, which projection and recess with threads are corresponding so that cassettes can be assembled by turning the cassettes relatively to each other. It should be mentioned that this way of assembling may also be applied to the assembling of the inlet and outlet elements 31, 32 with the cassettes 1 in the shown in FIGS. 13 and 14.

FIG. 16 shows schematically a processing unit 29 according to the present invention (the overall flow direction is as in FIG. 13). The processing unit 29 is formed as an elongated unit having a cylindrical casing and the unit comprises five cassettes 1, an inlet element 31, an outlet element 32 and a motor 22 for rotating impellers 6 arranged in the processing unit 29. Each of the cassettes 1 has a constant cross section in the longitudinal direction of the processing unit although the cross section varies among the cassettes 1. Also in this embodiment, two of the cassettes 1 comprise connections 37 such as sockets housing fluid interaction components such as the sockets 8 disclosed in connection with FIGS. 1-12.

FIG. 17 shows schematically a longitudinal cross section of a processing unit 29 according to the present invention. The processing unit is formed as an elongated unit having a cylindrical casing and comprises five cassettes 1, an inlet element 31, an outlet element 32 and a motor 22 with a shaft 7 for rotating impellers (not shown) arranged in the processing unit 29; fluid interaction components as well as the flow passages are not shown in the figure.

The part of the unit's casing 30 extending along the cassettes 1 is a composite casing composed by a tubular part 44 and the outer housings 2 of the cassettes 1. Other structures may be included in the composite casing, such as sealing elements, further tubular elements, securing elements guides etc. The internal diameter of the tubular part 44 is chosen in respect to the outer diameter of the cassettes 1, so that a snug fit between the wall of the tubular part 44 and the outer housings 2 of the cassettes 1 is provided. Thus, as the outer housing 2 abuts the tubular part 44 and thereby provides a composite casing, the outer housings 2 of the cassettes 1 form a part of casing 30. It should be mentioned that although the outer housings 2 of the cassettes 1 are shown as abutting the tubular part 44 along the entire longitudinal extension of cassettes 1 this may not always be the situation. For instance, the some or all of the outer housings 2 may be recessed along the side of the outer housing 2 facing towards the interior surface of the tubular part 44 so that only a part of the outer housings 2 abuts the tubular part 44.

Assembly of the processing units disclosed in connection with FIGS. 16 and 17 may be provided in the manner disclosed in connection with FIGS. 14 and 15. However, the processing units 29 according to FIG. 17 may preferably be assembled by providing threads in the recess 42 of the inlet element 31, the outlet elements 32 and on the outer wall of the tubular part 44 so that the processing unit 29 is assembled by turning the inlet and outlet elements 31, 32 relatively to the tubular part 44.

FIG. 18 shows a part of the embodiment shown in FIG. 13, further comprising a pressure increasing step provided in the inlet element 31 by arranging a number of impellers 6 to form a pressure increasing stack of impellers 6 which impellers are arranged on the common shaft 7. The pressure increase provided by the stack of impellers 6 is larger than the pressure drop resulting from the flow and processing of the fluid in the cassettes 1, and the fluid thereby leaves the processing unit 29 at an increased pressure level relatively to the pressure of the fluid at the inlet 35. At the same time the fluid is processed, e.g. by addition of substances, exposure to radiation etc. It should be mentioned that such a pressure increase may also be provided by dimensioning the impellers 6 in the cassettes to provide the pressure increase whereby the stack of impellers arranged in the inlet element need not to be present.

Although the description of the present invention presented herein focus on impellers for driving the fluid through the processing unit, other types of total pressure increasing means may be used. However, in connection with the present invention it has been found that impellers are advantageous, as the impellers provide a flow which includes a swirling velocity component in the fluid flowing through the one or more of the cassettes or the whole processing unit. Such a swirling velocity component may be used to increase mixing and interaction with the fluid interaction component in the unit which may be utilised to process the fluid more intensively while keeping the overall outer dimensions of the processing unit low and the velocity the unit high.

It should be mentioned that although the above description focuses on embodiments wherein the cassettes comprise structures as indicated e.g. in FIG. 1, the feature of the cassette should preferably be interpreted broadly, and cassettes not including some or all of the features indicates in e.g. FIG. 1 is considered to be within the scope of the present invention. However, a common feature of a cassette according to the present invention is preferably a structure being adapted to interact with the fluid flowing through the cassette which interaction is typically and preferably performed by a fluid interaction component and having an outer housing being arranged so that the outer housing form at least part of the casing. One such example is outlined below wherein the fluid interaction component comprising a decanter.

FIG. 19 shows a preferred embodiment of a decanter cassette 1 comprising a fluid interaction component in the form of a decanter 50 for separating e.g. water from sludge; FIG. 19a shows a three-dimensional view of the cassette and FIG. 19b shows a cross sectional view along line A-A in FIG. 19a. The decanter 50 comprises a confined screw 51 and the fluid to be treated is transported into the decanter from a position downstream of the screw 51. The decanter 50 is arranged on a shaft 7 and rotated by rotation of the shaft 7. The rotation of the decanter will result in transportation of e.g. water separated from the fluid to be treated upstream in the decanter 50 and transportation of e.g. sludge downstream in the decanter. Although, the arrows indicating the flow of sludge and water respectively in FIG. 19b is shown as two separate streams of fluids flowing into the decanter 50, the sludge and water are mixed when it flows into the decanter 50. Water and sludge leaves the decanter 50 through penetrations 52 whereof one is shown in FIG. 19b.

The upstream part 1a of the decanter cassette 1 may as shown in FIG. 19 be made from a cassette similar to the cassette shown in FIG. 1. In such cases, the decanter cassette comprises an interaction introduction passage 5 in which e.g. a sensor may be arranged by use of the socket 8 for measuring one or more properties of the fluid leaving the decanter 50. Similarly, the downstream part 1b of decanter cassette may shown in FIG. 19 be made from a cassette similar to cassette shown in FIG. 1 as and may therefore also comprising an interaction introduction passage 5. Sludge may be taken out through a socket 8. In the upstream or downstream parts 1a, 1b or in both an impeller may be arranged, which impellers may be arranged on the shaft 7 for rotation.

FIG. 20 shows schematically a cassette 1 of a fluid processing unit according to a preferred embodiment of the invention wherein the fluid interaction component is an ultra sound horn 61; FIG. 20a shows the cassette 1 in a partly exploded view and FIG. 6b shows a segment of a cross sectional view taken along a radius of the cassette 1 with the shaft 7 removed. Arrows labeled F in the figure indicates the flow of the fluid through the cassette 1.

As shown in FIG. 20a, the cassette is similar to one of the cassettes shown in FIG. 4 although the cassette in FIG. 20 does not comprise the shield 14 and the radiation source 15. Instead, an ultra sound generator 62 with an ultra sound horn 61 is arranged to emit ultra sound to the interaction introducing passage 5. A flow guide 63 is also arranged within the interaction introducing passage 5. The flow guide 63 leaves a passage open between the ultra sound horn 61 and the end of the flow guide 63 whereby the flow guide 63 assists in guiding the fluid towards the ultra sound horn 61. The flow guide 63 may furthermore be excited by the sound waves emitted from the ultra sound horn 61.

An impeller 6 is arranged within a guide element 26 which guide element 26 guides the fluid through the impeller 8.

Also in this case a number of cassettes 1 may be stacked similar to what is shown in e.g. FIG. 3, and the stack may be incorporated in the embodiments shown in FIGS. 13 and 14. Furthermore, such a stack of treatment stages may comprise different treatment sources to provide different treatment technologies, for instance a combination of the UV treatment and the ultra sound treatment.

FIG. 21 shows schematically a preferred embodiment of a cassette 1 adapted to carrying out measurements in a fluid flowing through the cassette; FIG. 21 shows the cassette in a 3-dimensional view. The cassette shown in FIG. 21, for short termed a measuring cassette, comprises a cylindrical outer housing 2, shown in FIG. 21a but not in 21b, and a wall element 3. In the embodiment shown in FIG. 21, the wall element 3 defines a cavity 4a above the wall element 3, whereas the cavity 4b as disclosed e.g. in connection with FIG. 4 is not present although the cavity 4b may be present if the wall element is arranged in an upstream position in the cassette 1. A cover, covering the open end of the cassette 1 is also not disclosed in FIG. 2 but will be disclosed in further details below.

Inside of the outer housing 2 a centrally arranged impeller 6 is present. Furthermore, spiraling wall 70 has been arranged on the wall element 3 as shown in FIG. 21 and the cassette furthermore comprises two sensors 71 and 72 as also indicated in FIG. 21.

The fluid flows through the measuring cassette as indicated by the arrows labeled F in FIG. 21b. As shown the fluid leaves the impeller 6 in a spiraling motion and flows assisted by the spiraling wall 70 into a channel 73 provided in the spiraling wall 70 in combination with the inner surface of the outer housing 2 abutting the surfaces labeled 70′ in FIG. 21b.

As shown in FIG. 21b, the channel 73 comprises a converging section 73′ and a section 73″ having a constant cross section as seen from the flow. In order to force the fluid flowing out of the impeller 6 into the channel 73, a cover (not shown) is provided on top of the cassette 1. This cover is sealed to the upper rim of the outer housing 2 as well as to the upper rim of the spiraling wall 70 and comprises an outlet at the position labeled 74 in FIG. 21b. Thereby, fluid will leave the cassette at the outlet of the cover at position 74.

In the embodiment shown in FIG. 21, two sensors 71, 72 are present. The sensor 71 is a flow sensor measuring the volume of the fluid flowing through the cassette 1. The sensor 1 is arranged upstream of the converging section 73′ in the section 73″ having a constant cross section. Upstream of the sensor, a wedge 75 is arranged which wedge 75 generates a wake as a Káarmáan vortex street. The wake, and in particular characteristic frequencies are used to determine the volume flow through the channel and thereby the flow through the cassette as all fluid flows through the channel.

The sensor 72 shown is a pH-sensor but other types of sensors may be applied. In general, a number of sensors may be arranged such as temperature, turbidity, turbulence sensors.

A further embodiment (not shown) of a cassette is adapted to exchange heat between at least two fluids. In such embodiments channels are provided in the cassette for the two fluids to flow through so that heat is exchanged between the two fluids through the walls of the channels. The cassette preferably comprises total pressure increasing means arranged to pump one or both fluids through the cassette

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A fluid processing unit through which fluid may flow while being processed, the fluid processing unit comprising
a casing,
one or more cassettes each comprising an outer housing being arranged so that the outer housing forms at least a part of the casing and each comprising a flow passage through the cassette,
wherein
at least one of the cassettes comprises at least one fluid interaction component or is adapted to receive at least one fluid interaction component, and
the fluid processing unit comprises total pressure increasing means for at least partially overcoming the pressure loss due to the fluid flowing through the unit, the total pressure increasing means and one, more or all of the one or more fluid interaction components being encapsulated by the casing.

2. A fluid processing unit according to claim 1, wherein the unit comprises a number, more than one, of cassettes.

3. A fluid processing unit according to claim 1 or 2, wherein the cassettes are combinable, such as stackable, to form the fluid processing unit or at least a part thereof.

4. A fluid processing unit according to any of the preceding claims, wherein at least one of the cassette(s) comprises at least one fluid interaction component and a total pressure increasing means.

5. A fluid processing unit according to any of the preceding claims, wherein the unit comprises more than one cassette, wherein
the cassettes are combinable whereby the fluid processing unit comprises a number of combined cassettes
and wherein
more than one of the cassettes each comprise at least one fluid interaction component and a total pressure increasing means.

6. A fluid processing unit according to any of the preceding claims, wherein one or more of the cassettes comprise(s) an interaction introducing passage in the flow passage.

7. A fluid processing unit according to any of the preceding claims, wherein the casing is pressure carrying.

8. A fluid processing unit according to any of the preceding claims, wherein the unit further comprises an outlet element arranged downstream of the one or more cassettes and/or an inlet element being arranged upstream of the one or more cassettes, the outer surface of the outlet element and/or inlet element comprising an outer housing being arranged so that the outer housing(s) form(s) at least part of the casing of the processing unit.

9. A fluid processing unit according to claim 8, wherein the total pressure increasing means or at least some of them is/are arranged in the inlet and/or outlet element.

10. A fluid processing unit according to claim 2 or any of claims 3-9 when dependent on claim 2, wherein the two or more cassettes are arranged along a common axis.

11. A fluid processing unit according to any of the preceding claims, wherein the fluid processing unit comprises a number of total pressure increasing means in the form of impellers and wherein some or all of the impellers are rotated by a common shaft.

12. A fluid processing unit according to claim 11, wherein some or all of the impellers are arranged in cassettes.

13. A fluid processing unit according to claim 2 or any of claims 3-12 when dependent on claim 2, wherein the outer geometry of all cassettes of the fluid processing unit are equal.

14. A fluid processing unit according to any of the preceding claims, wherein the cross section of the outer housing of one or more of the cassettes is constant along one direction.

15. A fluid processing unit according to any of the preceding claims, wherein the outer housing of one or more of the cassettes forming at least a part of the casing forms at least a part of an outer surface of the casing.

16. A fluid processing unit according to any of the preceding claims, wherein the outer housing of one or more of the cassettes forming at least a part of the casing abuts an interior surface of the casing.

17. A fluid processing unit according to any of the preceding claims, wherein one or more of the cassettes comprise(s) total pressure increasing means.

18. A fluid processing unit according to any of the preceding claims, wherein one or more of the cassettes comprise(s) one or more fluid interaction components adapted to perform one or more chemical unitary operations.

19. A fluid processing unit according to any of the preceding claims, wherein one or more of the cassettes comprise(s) a socket (8) adapted to house the fluid interaction component.

20. A fluid processing unit according to any of the preceding claims, wherein one or more of the cassettes is/are adapted to maintain and/or provide a three dimensional flow in at least a part of the flow passage.

21. A fluid processing unit according to any of the preceding claims, wherein one or more of the cassettes comprise(s) an inlet where fluid flows into the cassette and an outlet where fluid flows out of the cassette, the inlet and outlet being connected to the flow passage.

22. A fluid processing unit according to any of the preceding claims, wherein one or more of the cassettes is/are adapted to receive or comprise(s) a velocity inducer.

23. A fluid processing unit according to claim 22, wherein the velocity inducer constitutes at least a part of the flow passage.

24. A fluid processing unit according to claim 22 or 23, wherein the velocity inducer constitutes at least a part of the flow passage and wherein an interaction introducing passage (5) is located upstream or downstream of the velocity inducer in the cassette.

25. A fluid processing unit according to any of the claims 22-24, wherein the velocity inducer is adapted to receive fluid at one velocity and deliver the fluid at a higher velocity.

26. A fluid processing unit according to any of the claims 22-25, wherein the velocity inducer is adapted to pump fluid through the cassette.

27. A fluid processing unit according to any of the claims 22-26, wherein the velocity inducer is adapted to receive fluid in one direction and deliver the fluid in another direction.

28. A fluid processing unit according to any of the preceding claims comprising at least two, such as at least three, preferably at least four interaction introducing passages.

29. A fluid processing unit according to claim 28, wherein at least two of the interaction introducing passages are similar, such as identical to each other.

30. A fluid processing unit according to claim 28 or 29, wherein all interaction introducing passages are identical.

31. A fluid processing unit according to claim 19 or any of the claims 20-30 when dependent on claim 19, wherein one or more of the cassettes comprise(s) at least one interaction introducing passage (5) comprised in the flow passage and wherein the socket (8) extends into the interaction introducing passage (5) so that when a fluid interaction component is present in the socket, the fluid flowing through the interaction introducing passage interacts with the fluid interaction component.

32. A fluid processing unit according to claim 31, wherein one or more of the flow passage(s) comprise(s) a first cavity and a second cavity being in fluid communication via the interaction introducing passage connecting the first and the second cavity so that fluid may flow from the first cavity through the interaction introducing passage and to the second cavity.

33. A fluid processing unit according to claim 32, wherein a velocity inducer, such as an impeller, is arranged upstream of the first cavity.

34. A fluid processing unit according to any of the claims 6-33, wherein the shape of the interaction introducing passage(s) provides an acceleration of the fluid through the interaction introduction passage.

35. A fluid processing unit according to any of the claims 32-34, wherein the first and the second cavities are arranged so that fluid may only flow from the first cavity to the second through the interaction introducing passage.

36. A fluid processing unit according to any of the preceding claims, wherein one or more of the cassettes comprise(s) a closable re-circulation channel for re-circulating at least a part of fluid from a position downstream of an fluid interaction component to a position upstream of a fluid interaction component.

37. A fluid processing unit according to claim 19 or any of claims 20-36 when dependent on claim 19, wherein one or more interaction elements are arranged in the socket.

38. A fluid processing unit according to any of the preceding claims, wherein the outer housing of one or more of the cassettes is adapted to be pressure carrying.

39. A fluid processing unit according to any of the preceding claims, wherein one or more of the cassettes comprise(s) means for agitating the fluid flowing through the cassettes.

40. A fluid processing unit according to any of the preceding claims, wherein one or more of the cassettes comprise(s) a wall element (3) arranged perpendicular to a flow direction through the cassette defined as the direction extending from inflow to outflow of the cassette, the wall element comprising one or more penetrations through which the fluid flow inside the cassettes.

41. A fluid processing unit according to any of the preceding claims, wherein the casing or at least a part thereof is thermal insolated

42. A fluid processing unit according to any of the preceding claims, wherein the casing or at least a part thereof comprises a cooling and/or heating jacket.

43. A fluid processing unit according to any of the preceding claims, further comprising a fluid collector for collecting fluid leaking from the processing unit.

44. A fluid processing unit according to any of the preceding claims, wherein at least one of the cassettes is made from different materials.

45. A fluid processing unit according to any of the preceding claims, wherein at least one of the cassettes is made from a single material.

46. A fluid processing unit according to claim 2 or any of the claims 3-45 when dependent on claim 2, wherein all the cassettes each are made from different materials.

47. A fluid processing unit according to any of the preceding claims, wherein the material(s) of the cassettes is/are selected from metal, composites materials, coated material, plastic, ceramics or combinations thereof.

48. A fluid processing unit according to any of the preceding claims, wherein the processing unit comprises one or more valves arranged to control the flow in and/or out of the processing unit.

49. A fluid processing unit according to any of the preceding claims, wherein the unit has a longitudinal extension and wherein the fluid processing unit comprises means for fixating the cassettes in a direction being perpendicular to the longitudinal direction.

50. A fluid processing unit according to any of the preceding claims, wherein the unit has a longitudinal extension and pressure in a direction being perpendicular to this direction is balanced by o-rings to provide a fluid tight sealing.

51. A fluid processing unit according to any of the preceding claims, wherein the unit has a longitudinal extension and comprising stays, preferably in the form of stay bolts extending in the direction of the longitudinal extension, the stay being arranged to balance pressure in the unit in longitudinal direction.

52. A fluid processing unit according to any of the preceding claims, the unit comprising an energy source for providing energy to energy demanding means, such as total pressure increasing means and/or velocity inducers, inside the fluid processing unit.

53. A fluid processing unit according to claim 52, wherein the energy source comprises an electrically driven motor.

54. A fluid processing unit according to any of the preceding claims, the unit comprising a shaft extending through two or more, such as all of the cassettes of the unit.

55. A fluid processing unit according to claim 54, wherein the shaft extends outside the unit and is connected to a motor, preferably being an electrically driven motor arranged outside the unit.

56. A fluid processing unit according to any of the preceding claims, wherein one, some or all of the fluid interaction components comprise(s) an electromagnetic radiation source, such as an UV light source.

57. A fluid processing unit according to any of the preceding claims, wherein one, some or all of fluid interaction components comprise(s) one or more nozzles.

58. A fluid processing unit according to any of the preceding claims, wherein one, some or all of the fluid interaction components comprise(s) one or more process active surfaces, such as one or more filter surfaces for filtering fluid, one or more catalytic surfaces for providing a catalytic process, one or more heat exchanger surfaces, one or more absorber surfaces, one or more condenser surfaces, one or more stripper surface, one or drying surfaces, one or more surfaces for carrying biological growth, one or more surfaces for crystallization, one or more surfaces for ion exchanging, one or more membrane surfaces or combination thereof.

59. A fluid processing unit according to any of the preceding claims, wherein one, some or all of the fluid interaction components comprise(s) surfaces for establishing an electromagnetic field so as to perform an electrolytic process, electro-dialytic process, electro de-ionization process or combinations thereof.

60. A fluid processing unit according to any of the preceding claims, wherein one, some or all of the fluid interaction components comprise(s) means for exposing fluid to radiation such as magnetic radiation, ultraviolet radiation, radioactive radiation, ultra sound, microwaves, laser radiation or combinations thereof.

61. A fluid processing unit according to any of the preceding claims, wherein one, some or all of the fluid interaction components comprise(s) a separator, a centrifuge, means for milling, means for homogenization, a decanter, a transporter for transporting e.g. particles, ion exchanging substances, a mixer or combinations thereof.

62. A fluid processing unit according to any of the preceding claims, wherein one, some or all of the fluid interaction components comprise(s) dosing means, means for degassing, distillation, aeration, such as atmospheric air, oxygen, ozone, chlorine, means for evaporation, means for reducing the pressure e.g. for vacuum distillation, means for steam treatment or combinations thereof.

63. A fluid processing unit according to any of the preceding claims, the fluid processing unit comprising one or more elements adapted to provide the fluid a given retention time in a cavity.

64. A fluid processing unit according to any of the preceding claims, wherein the fluid processing unit comprise(s) a reactor for performing a biological process, a chemical process, a fuel cell process or a combination thereof.

65. A fluid processing unit according to any of the preceding claims, wherein one, some or all of the fluid interaction components comprise(s) a heat source, such as an electrical heater.

66. A fluid processing unit according to any of the preceding claims, the unit comprising means for rotating elements, such as impellers, within the unit

67. A fluid processing unit according to claim 66, wherein the means for rotating elements comprise(s) one or more gears.

68. A fluid processing unit according to claim 66 or 67, wherein the means for rotating elements comprise(s) one or more couplings means, such as mechanical coupling means, magnetic coupling means, viscous friction coupling means, inductive coupling means or combinations thereof.

69. A fluid processing unit according to any of the claims 66-68, wherein the element is a part of an electromotor or a generator.

70. A fluid processing unit according to any of the preceding claims, wherein the processing unit comprise(s) a turbine encapsulated by the casing.

71. A fluid processing unit according to any of the preceding claims, wherein the processing unit comprise(s) a displacement pump encapsulated by the casing.

72. A fluid processing unit according to claim 19 or any of claims 20-71 when dependent on claim 19, wherein one or more of the sockets (8) are adapted to house one or more fluid interaction components in a releasable manner so that the fluid interaction component(s) may be reversible removed from and inserted into the socket.

73. A fluid processing unit according to claim 2 or any of claims 3-72 when dependent on claim 2, wherein the cassettes are stackable.

74. A fluid processing unit according to any of the preceding claims, wherein one, more or all of the fluid interaction components comprise(s) a pressure sensor, a temperature sensor, a fluid velocity sensor, a mass flow sensor, a volumetric flow sensor, a pH-sensor, a conductivity sensor, an organic content sensor, a capacitance sensor, a turbidity sensor, a radiation sensor, a spectrometric sensor or combinations thereof.

75. A fluid processing unit according to any of the preceding claims, wherein the unit comprises a plurality of cassettes with individually different fluid interaction components.

76. A cassette comprising an outer housing being arranged so that the outer housing forms at least a part of a casing of a fluid processing unit when at least two cassettes are combined to form at least a part of the fluid processing unit, the cassette further comprising a flow passage through the cassette and the cassette further comprises or is adapted to receive at least one fluid interaction component.

77. A method for providing an interaction between a fluid and an interaction component, the method comprising feeding fluid to a fluid processing unit according to any of claims 1-75.
